(19) United States
(12) Patent Application Publication
(10) Pub. No.: US 2026/0089526 A1
(43) Pub. Date: Mar. 26, 2026

(54) TERMINAL APPARATUS, METHOD, AND INTEGRATED CIRCUIT

(71) Applicant: SHARP KABUSHIKI KAISHA, Sakai City, Osaka (JP)

(72) Inventors: Takuma KAWANO, Sakai City, Osaka (JP); HIDEKAZU TSUBOI, Sakai City, Osaka (JP); SHOHEI YAMADA, Sakai City, Osaka (JP); TAICHI MIYAKE, Sakai City, Osaka (JP); Kyosuke INOUE, Sakai City, Osaka (JP); Takaki NOMURA, Sakai City, Osaka (JP)

(21) Appl. No.: 19/144,397

(22) PCT Filed: Jan. 9, 2025
(86) PCT No.: PCT/JP2025/000494

§ 371 Date: Jun. 27, 2025

(30) Foreign Application Priority Data
Jan. 22, 2024 (JP) 2024-007230

(51) Int. Cl. H04W 24/08; H04W 88/04

(52) U.S. Cl. CPC H04W 24/08; H04W 88/04

(57) ABSTRACT

A terminal apparatus configured to communicate with a base station apparatus includes a transmitter and a processing unit, in which the processing unit determines whether a procedure of changing an indirect path and a procedure of adding the indirect path are ongoing in a case that a radio link failure of a direct path is detected, the transmitter reports the radio link failure of the direct path to the base station apparatus, based on the processing unit determining that neither the procedure of changing the indirect path nor the procedure of adding the indirect path is ongoing, the direct path is a path connected to the base station apparatus via a Uu interface, and the indirect path is a path connected to the base station apparatus via a relay terminal apparatus.

### TECHNICAL FIELD

The present invention relates to a terminal apparatus, a method, and an integrated circuit.

This application claims priority to Japanese Patent Application No. 2024-007230, filed in Japan on Jan. 22, 2024, the contents of which are incorporated herein by reference.

### BACKGROUND ART

In the 3rd Generation Partnership Project (3GPP) [registered trademark], which is a standardization project for cellular mobile communication systems, technical studies and standardization are being conducted for cellular mobile communication systems, including radio access, a core network, and services.

For example, technical study and standardization of Evolved Universal Terrestrial Radio Access (E-UTRA) have begun in the 3GPP as a Radio Access Technology (RAT) for cellular mobile communication systems for the 3.9th generation and the 4th generation. Technical study and standardization of enhanced technology of E-UTRA are still being carried out in the 3GPP. Note that E-UTRA may also be referred to as Long Term Evolution (LTE: trade name), and its enhanced technology may also be referred to as LTE-Advanced (LTE-A) and LTE-Advanced Pro (LTE-A Pro).

Technical study and standardization of New Radio or NR Radio access (NR) have begun in the 3GPP as a Radio Access Technology (RAT) for cellular mobile communication systems for the 5th Generation (5G). Technical study and standardization of enhanced technology of NR are still carried out in the 3GPP.

### CITATION LIST

### Non Patent Literature

NPL 1:3GPP TS 38.331 v18.0.0, “Evolved Universal Terrestrial Radio Access (E-UTRA); Radio Resource Control (RRC); Protocol specifications”

NPL 2:3GPP TS 38.321 v18.0.0, “NR; Medium Access Control (MAC) protocol specification” pp17-104

NPL 3:3GPP TS 38.213 v17.1.0, “NR; Physical layer procedures for control” pp14-20

NPL 4:3GPP TS 38.300 v18.0.0, “NR; NR and NG-RAN Overall Description; Stage 2”

NPL 5:3GPP TS 38.351 v17.1.0, “NR; Sidelink Relay Adaptation Protocol (SRAP) Specification”

### SUMMARY OF INVENTION

### Technical Problem

In 3GPP, as an extension technology for NR, a technology called sidelink (SL) in which terminal apparatuses communicate with each other directly without doing so via a core network has been examined, and a technology called UE-to-network relay (U2N relay) in which a relay terminal apparatus provides communication via a sidelink, allowing a terminal apparatus to communicate with a base station apparatus via the relay terminal apparatus has also been considered. Furthermore, research has begun into a technology called multi-path relay, which communicates with a base station apparatus using two (or more) types of paths including an indirect path that uses a U2N relay to communicate with a base station apparatus, and a direct path that communicates directly with the base station apparatus without using the U2N relay.

An aspect of the present invention is made in view of the circumstances described above, and has an object to provide a terminal apparatus, a base station apparatus, a communication method, and an integrated circuit that enable efficient communication control.

### Solution to Problem

In order to accomplish the object described above, an aspect of the present invention is contrived to provide the following means. That is, an aspect of the present invention is a terminal apparatus configured to communicate with a base station apparatus, the terminal apparatus including: a transmitter; and a processing unit, in which the processing unit determines whether a procedure of changing an indirect path and a procedure of adding the indirect path are ongoing in a case that a radio link failure of a direct path is detected, the transmitter reports the radio link failure of the direct path to the base station apparatus, based on the processing unit determining that neither the procedure of changing the indirect path nor the procedure of adding the indirect path is ongoing, the direct path is a path connected to the base station apparatus via a Uu interface, and the indirect path is a path connected to the base station apparatus via a relay terminal apparatus.

Further, an aspect of the present invention is a method for a terminal apparatus configured to communicate with a base station apparatus, the method including: determining whether a procedure of changing an indirect path and a procedure of adding the indirect path are ongoing in a case that a radio link failure of a direct path is detected; and reporting the radio link failure of the direct path to the base station apparatus, based on determining that neither the procedure of changing the indirect path nor the procedure of adding the indirect path is ongoing, in which the direct path is a path connected to the base station apparatus via a Uu interface, and the indirect path is a path connected to the base station apparatus via another terminal apparatus.

Further, an aspect of the present invention is an integrated circuit implemented in a terminal apparatus configured to communicate with a base station apparatus, the integrated circuit including: a function of determining whether a procedure of changing an indirect path and a procedure of adding the indirect path are ongoing in a case that a radio link failure of a direct path is detected; and a function of reporting the radio link failure of the direct path to the base station apparatus, based on determining that neither the procedure of changing the indirect path nor the procedure of adding the indirect path is ongoing, in which the direct path is a path connected to the base station apparatus via a Uu interface, and the indirect path is a path connected to the base station apparatus via another terminal apparatus.

These comprehensive or specific aspects may be realized as a system, an apparatus, a method, an integrated circuit, a computer program, or a recording medium, or may be realized as any combination of a system, an apparatus, a method, an integrated circuit, a computer program, and a recording medium.

### Advantageous Effects of Invention

According to an aspect of the present invention, the terminal apparatus, the method, and the integrated circuit can realize efficient communication control processing.

### BRIEF DESCRIPTION OF DRAWINGS

FIG. 1 is a schematic diagram of a communication system according to the present embodiment.

FIG. 2 is a diagram of an example of a protocol architecture for NR sidelink communication according to the present embodiment.

FIG. 3 is a diagram of an example of a protocol architecture for NR sidelink communication according to the present embodiment.

FIG. 4 is a diagram illustrating an example of the protocol architecture in a discovery procedure according to the present embodiment.

FIG. 5 is a block diagram illustrating a configuration of a terminal apparatus according to the present embodiment.

FIG. 6 is a block diagram illustrating a configuration of a base station apparatus according to the present embodiment.

FIG. 7 is a diagram illustrating an example of a protocol architecture in an NR according to the present embodiment.

FIG. 8 is a diagram illustrating an example of a protocol architecture of a control plane of an L2 U2N relay according to the present embodiment.

FIG. 9 is a diagram illustrating an example of a protocol architecture of a user plane of the L2 U2N relay according to the present embodiment.

FIG. 10 is an example of processing according to the present embodiment.

### DESCRIPTION OF EMBODIMENTS

The present embodiment will be described below in detail with reference to the drawings.

In the present embodiment, terms of each node and entity, processing in each node and entity, and the like in a case that the radio access technology is NR will be described. However, the present embodiment may be applied to another radio access technology. In the present embodiment, the terms of each node and entity may be other terms.

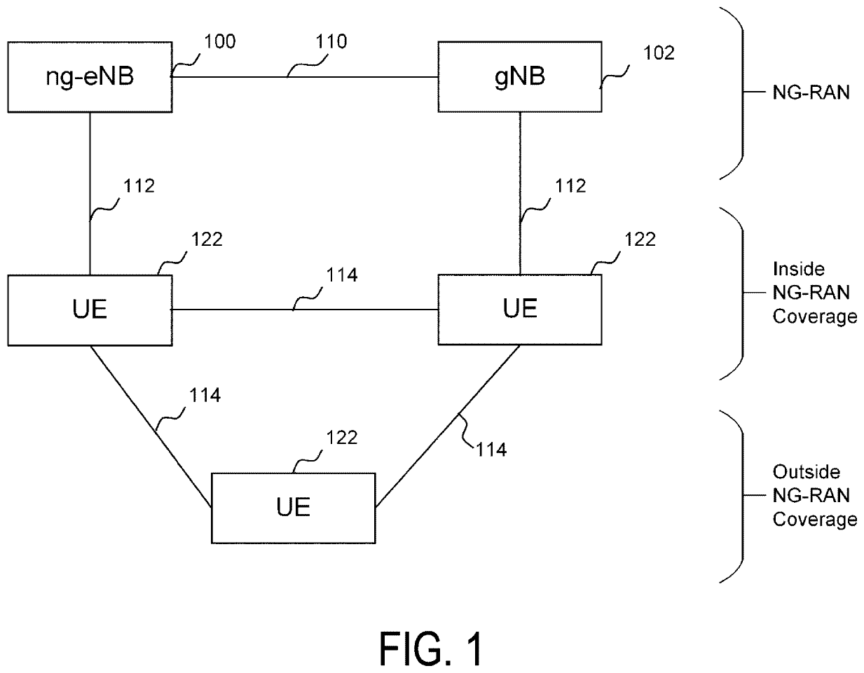

FIG. 1 is a schematic diagram of a communication system according to the present embodiment. Note that functions such as each node, radio access technology, core network, and interface to be described with reference to FIG. 1 are a part of functions closely according to the present embodiment, and other functions may be provided.

E-UTRA may be a radio access technology. The E-UTRA may be an air interface between a UE 122 and an ng-eNB 100. An air interface 112 between the UE 122 and the ng-eNB 100 may be referred to as a Uu interface. The ng-eNB (ng E-UTRAN Node B) 100 may be a base station apparatus of the E-UTRAN. The ng-eNB 100 may have an E-UTRA protocol to be described below. The E-UTRA protocol may include an E-UTRA User Plane (UP) protocol to be described below and an E-UTRA Control Plane (CP) protocol to be described below. The ng-eNB 100 may terminate the E-UTRA user plane protocol and the E-UTRA control plane protocol for the UE 122. A radio access network including the eNB may be referred to as an E-UTRAN.

NR may be a radio access technology. The NR may be an air interface between the UE 122 and a gNB 102. The air interface 112 between the UE 122 and the gNB 102 may be referred to as a Uu interface. The g Node B (gNB) 102 may be a base station apparatus of NR. The gNB 102 may have an NR protocol to be described below. The NR protocol may include an NR User Plane (UP) protocol to be described below and an NR Control Plane (CP) protocol to be described below. The gNB 102 may terminate the NR user plane protocol and the NR control plane protocol for the UE 122.

Note that the interface 110 between the ng-eNB 100 and the gNB 102 may be referred to as an Xn interface. The ng-eNB and the gNB may be connected to the 5GC via an interface called an NG interface (not illustrated). The 5GC may be a core network. One or multiple base station apparatuses may connect to the 5GC via the NG interface.

A state in which a connection to the base station apparatus can be made only via the Uu interface may be called Inside NG-RAN Coverage or In-Coverage (IC). Further, a state in which the connection to the base station apparatus cannot be made only via the Uu interface may be called Outside NG-RAN Coverage or Out-of-Coverage (OoC). An air interface 114 between the UE 122 and the UE 122 may be called a PC5 interface. Communication between the UEs 122 via the PC5 interface may be referred to as sidelink (SL) communication. A terminal apparatus that can perform sidelink communication may be referred to as a terminal apparatus capable of sidelink communication.

Note that, in the following description, the ng-eNB 100 and/or the gNB 102 is also simply referred to as a base station apparatus, and the UE 122 is also simply referred to as a terminal apparatus or a UE. The PC5 interface is also simply referred to as PC5, and the Uu interface is also simply referred to as Uu.

The sidelink is a technology for direct communication between terminal apparatuses via PC5, and sidelink transmission and/or reception on the PC5 is performed inside and outside the NG-RAN coverage.

NR SL communication has three transmission modes, and SL communication is performed in one of the transmission modes with a pair of a source layer-2 identifier (Source Layer-2 (L2) ID) and a destination layer-2 identifier (Destination Layer-2 (L2) ID). A source layer-2 identifier and a destination layer-2 identifier may be referred to as a source L2ID and a destination L2ID, respectively. The three transmission modes are “Unicast transmission”, “Groupcast transmission”, and “Broadcast transmission”. The transmission mode may also be referred to as a cast type, or the like. The unicast transmission for direct communication is supported on the PC5, and a PC5 unicast link between two UEs may be established for direct communication. Further, the PC5 unicast link may also be maintained, changed, or released in accordance with a request for an application layer or communication requirements.

The unicast transmission is characterized by: (1) support of one PC5-RRC connection between paired UEs; (2) transmission and/or reception of control information and user traffic between UEs on the sidelink; (3) support of sidelink HARQ feedback; (4) transmission power control on the sidelink; (5) support of RLC AM; and (6) detection of radio link failure for the PC5-RRC connection.

Groupcast transmission is characterized by (1) transmission and/or reception of user traffic between UEs belonging to a sidelink group and (2) support of sidelink HARQ feedback.

Broadcast transmission is characterized by (1) transmission and/or reception of user traffic between UEs on the sidelink.

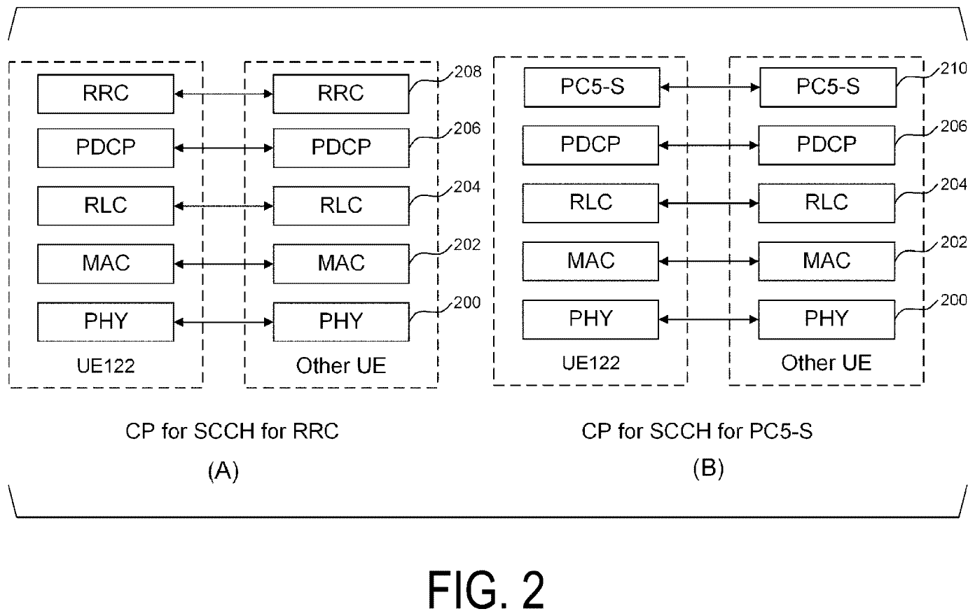

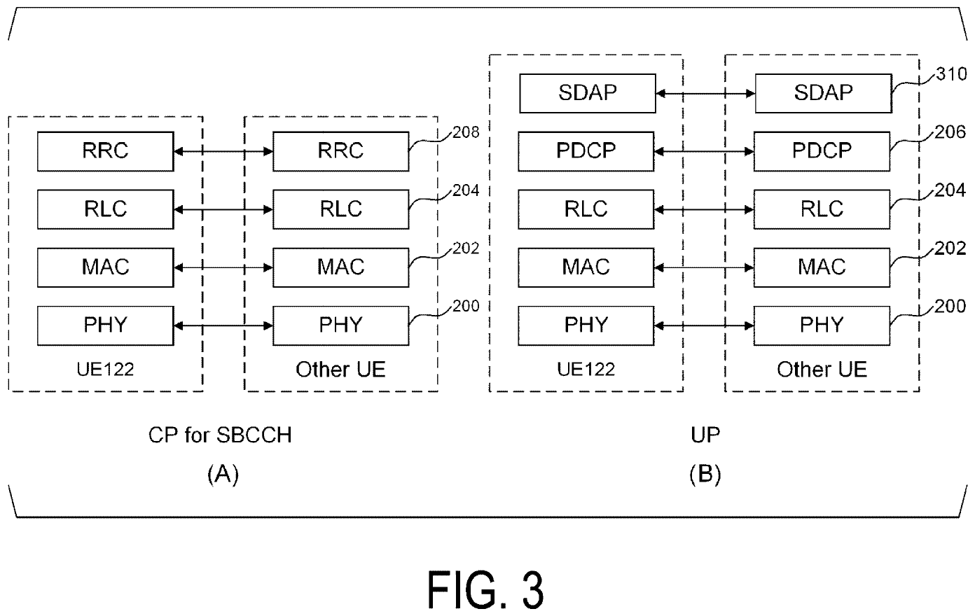

FIGS. 2 and 3 are diagrams of an example of a protocol architecture in NR sidelink communication according to the present embodiment. Note that functions of each protocol to be described with reference to FIG. 2 and/or FIG. 3 are a part of functions closely according to the present embodiment, and other functions may be provided. Note that, in the present embodiment, the sidelink (SL) may be a link between a terminal apparatus and a terminal apparatus.

FIG. 2(A) is a diagram of a protocol stack of the Control Plane (CP) for an SCCH with RRC, which is configured on the PC5 interface. As illustrated in FIG. 2(A), the control plane protocol stack for the SCCH with RRC may include a Physical layer (PHY) 200 which is a radio physical layer, a Medium Access Control (MAC) 202 which is a medium access control layer, a Radio Link Control (RLC) 204 which is a radio link control layer, and a Packet Data Convergence Protocol (PDCP) 206 which is a packet data convergence protocol layer, and a Radio Resource Control (RRC) 208 which is a radio resource control layer. FIG. 2(B) is a diagram of the protocol stack of the control plane for the SCCH with PC5-S, which is configured on the PC5 interface. As illustrated in FIG. 2(B), the control plane protocol stack for the SCCH with PC5-S may include the Physical layer (PHY) 200 which is a radio physical layer, the Medium Access Control (MAC) 202 which is a medium access control layer, the Radio Link Control (RLC) 204 which is a radio link control layer, and the Packet Data Convergence Protocol (PDCP) 206 which is a packet data convergence protocol layer, and a PC5 Signalling (PC5-S) 210 which is a PC5 signaling layer.

FIG. 3(A) is a diagram of the protocol stack of the control plane for an SBCCH, which is configured on the PC5 interface. As illustrated in FIG. 3(A), the control plane protocol stack for the SBCCH may include the Physical layer (PHY) 200 which is a radio physical layer, the Medium Access Control (MAC) 202 which is a medium access control layer, the Radio Link Control (RLC) 204 which is a radio link control layer, and the Radio Resource Control 208 (RRC) which is a radio resource control layer. FIG. 3(B) is a diagram of the protocol stack of the User Plane (UP) for an STCH, which is configured on the PC5 interface. As illustrated in FIG. 3(B), the control plane protocol stack for the STCH may include the Physical layer (PHY) 200 which is a radio physical layer, the Medium Access Control (MAC) 202 which is a medium access control layer, the Radio Link Control (RLC) 204 which is a radio link control layer, the Packet Data Convergence Protocol (PDCP) 206 which is a packet data convergence protocol layer, and a Service Data Adaptation Protocol (SDAP) 310 which is a service data adaptation protocol layer.

Note that an Access Stratum (AS) layer may be a layer including a part or all of the PHY 200, the MAC 202, the RLC 204, the PDCP 206, the SDAP 310, and the RRC 208. The PC5-S 210 and a Discovery 400 described below may be layers higher than the AS layer.

Note that the present embodiment may use terms such as a PHY (PHY layer), a MAC (MAC layer), an RLC (RLC layer), a PDCP (PDCP layer), an SDAP (SDAP layer), an RRC (RRC layer), and a PC5-S (PC5-S layer). In this case, the PHY (PHY layer), the MAC (MAC layer), the RLC (RLC layer), the PDCP (PDCP layer), the SDAP (SDAP layer), the RRC (RRC layer), and the PC5-S (PC5-S layer) may respectively be the PHY (PHY layer), the MAC (MAC layer), the RLC (RLC layer), the PDCP (PDCP layer), the SDAP (SDAP layer), the RRC (RRC layer), and the PC5-S (PC5-S layer) of the NR sidelink protocol. Note that, in a case that sidelink communication is performed using the E-UTRA technology, the SDAP layer need not be provided. In order to clarify that the protocol is for sidelink, for example, the RLC may be expressed as a sidelink RLC, SLRLC, PC5 RLC, or the like, and for other protocols, the protocols may be expressed as protocols for sidelink by adding “sidelink”, “SL”, or “PC5” to a beginning.

Further, in the present embodiment, hereinafter, in a case that the E-UTRA protocol is distinguished from the NR protocol, PHY, MAC, RLC, PDCP, and RRC may be referred to as PHY for E-UTRA or PHY for LTE, MAC for E-UTRA or MAC for LTE, RLC for E-UTRA or RLC for LTE, PDCP for E-UTRA or PDCP for LTE, and RRC for E-UTRA or RRC for LTE, respectively. Further, PHY, MAC, RLC, PDCP, and RRC may be described as E-UTRA PHY or LTE PHY, E-UTRA MAC or LTE MAC, E-UTRA RLC or LTE RLC, E-UTRA PDCP or LTE PDCP, and E-UTRA RRC or LTE RRC, respectively. Further, in a case that the E-UTRA protocol is distinguished from the NR protocol, PHY, MAC, RLC, PDCP, and RRC may be referred to as PHY for NR, MAC for NR, RLC for NR, RLC for NR, and RRC for NR, respectively. Further, PHY, MAC, RLC, PDCP, and RRC may be described as NR PHY, NR MAC, NR RLC, NR PDCP, and NR RRC, respectively.

Entities in the AS layer of E-UTRA, NR, and/or sidelink will be described. An entity having a part or all of functions of the physical layer may be referred to as a PHY entity. An entity having a part or all of functions of the MAC layer may be referred to as a MAC entity. An entity having a part or all of functions of the RLC layer may be referred to as an RLC entity. An entity having a part or all of functions of the PDCP layer may be referred to as a PDCP entity. An entity having a part or all of functions of the SDAP layer may be referred to as an SDAP entity. An entity having a part or all of functions of the RRC layer may be referred to as an RRC entity. The PHY entity, the MAC entity, the RLC entity, the PDCP entity, the SDAP entity, and the RRC entity may respectively be replaced with a PHY, a MAC, an RLC, a PDCP, an SDAP, and an RRC. Further, each entity in the AS layer may be a common entity for E-UTRA, NR, and/or sidelink, or may be an independent entity.

Note that data provided from the MAC, the RLC, the PDCP, and the SDAP to a lower layer, and/or data provided to the MAC, the RLC, the PDCP, and the SDAP from a lower layer may be referred to as a MAC Protocol Data Unit (PDU), an RLC PDU, a PDCP PDU, and an SDAP PDU, respectively. Data provided to the MAC, the RLC, the PDCP, and the SDAP from a higher layer, and/or data provided from the MAC, the RLC, the PDCP, and the SDAP to a higher layer may be referred to as a MAC Service Data Unit (SDU), an RLC SDU, a PDCP SDU, and an SDAP SDU, respectively. A segmented RLC SDU may be referred to as an RLC SDU segment.

Here, the base station apparatus and the terminal apparatus exchange (transmit and/or receive) signals with each other in higher layers on the Uu interface. The higher layer may be referred to as an upper layer, and may be paraphrased with each other. For example, the base station apparatus and the terminal apparatus may transmit and/or receive an RRC message (also referred to as RRC signaling) in the Radio Resource Control (RRC) layer. In the Medium Access Control (MAC) layer, the base station apparatus and the terminal apparatus may transmit and/or receive a MAC Control Element (MAC CE). Further, the RRC layer of the terminal apparatus acquires system information broadcast from the base station apparatus. In this regard, the RRC message, the system information, and/or the MAC control element are also referred to as higher layer signaling or a higher layer parameter. Each of the parameters included in the higher layer signaling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, an RLC layer, a PDCP layer, a Non Access Stratum (NAS) layer, and the like. For example, in the processing of the MAC layer, the higher layer may mean one or multiple of the RRC layer, the RLC layer, the PDCP layer, the NAS layer, and the like.

On the PC5 interface, the terminal apparatuses exchange (transmit and/or receive) signals with each other in higher layers. The terminal apparatuses may transmit and/or receive an RRC message (also referred to as RRC signaling) in the Radio Resource Control (RRC) layer. In the Medium Access Control (MAC) layer, the terminal apparatuses may transmit and/or receive a MAC Control Element (MAC CE). In this regard, the RRC message and/or the MAC control element are also referred to as higher layer signaling or a higher layer parameter. Each of the parameters included in the higher layer signaling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, the RLC layer, the PDCP layer, the PC5-S layer, the Discovery layer, and the like. For example, in the processing of the MAC layer, the higher layer may mean one or multiple of the RRC layer, the RLC layer, the PDCP layer, the PC5-S layer, the Discovery layer, and the like.

Hereinafter, “A is given (provided) in the higher layer” or “A is given (provided) by the higher layer” may mean that the higher layer (mainly the RRC layer, the MAC layer, or the like) of the terminal apparatus receives A from the base station apparatus or another terminal apparatus, and that the received A is given (provided) from the higher layer of the terminal apparatus to the physical layer of the terminal apparatus. For example, “a higher layer parameter being provided” in the terminal apparatus may mean that higher layer signaling is received from the base station apparatus or another terminal apparatus, and a higher layer parameter included in the received higher layer signaling is provided from the higher layer of the terminal apparatus to the physical layer of the terminal apparatus. A higher layer parameter being configured for the terminal apparatus may mean that the higher layer parameter is given (provided) to the terminal apparatus. For example, a higher layer parameter being configured for the terminal apparatus may mean that the terminal apparatus receives higher layer signaling from the base station apparatus or another terminal apparatus and configures the received higher layer parameter in the higher layer. However, a higher layer parameter being configured for the terminal apparatus may include a default parameter given in advance being configured in the higher layer of the terminal apparatus. In description of transmission of an RRC message from the terminal apparatus to the base station apparatus or another terminal apparatus, the expression that a message is submitted from the RRC entity of the terminal apparatus to a lower layer may be used. In the terminal apparatus, “submitting a message to a lower layer” from the RRC entity may mean submitting a message to the PDCP layer. In the terminal apparatus, “submitting a message to a lower layer” from the RRC layer may mean submitting the message of the RRC to a PDCP entity corresponding to each SRB (SRB0, SRB1, SRB2, SRB3, or the like) because the message is transmitted using the SRB. In a case that the RRC entity of the terminal apparatus receives an indication from the lower layer, the lower layer may mean one or more of a PHY layer, a MAC layer, an RLC layer, a PDCP layer, and the like.

An example of a function of the PHY will be described. The PHY of the terminal apparatus may have a function of transmitting and/or receiving transmitted data to and/or from the PHY of another terminal apparatus via a sidelink (SL) Physical Channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Here, the physical channels will be described. Physical channels used for radio communication between the terminal apparatus and another terminal apparatus may include the following physical channels.
Physical Sidelink Broadcast CHannel (PSBCH)
Physical Sidelink Control CHannel (PSCCH)
Physical Sidelink Shared CHannel (PSSCH)
Physical Sidelink Feedback CHannel (PSFCH)

The PSBCH may be used to broadcast system information required by the terminal apparatus.

The PSCCH may be used to indicate resources or other transmission parameters for the PSSCH.

The PSSCH may be used to transmit data and control information related to HARQ/CSI feedback to another terminal apparatus.

The PSFCH may be used to carry HARQ feedback to another terminal apparatus.

An example of a function of the MAC will be described. The MAC may be referred to as a MAC sublayer. The MAC may have a function of mapping various Logical Channels to their corresponding transport channels. The logical channel may be identified with a Logical Channel Identity (or Logical Channel ID). The MAC may be connected to an upper RLC with a logical channel. The logical channel may be classified into a control channel for transmitting control information and a traffic channel for transmitting user information depending on the type of information to be transmitted. The MAC may have a function of multiplexing MAC SDUs belonging to one or multiple different logical channels and providing the multiplexed MAC SDUs to the PHY. The MAC may have a function of demultiplexing the MAC PDUs provided from the PHY and providing the demultiplexed MAC PDUs to a higher layer via the logical channels to which the respective MAC SDUs belong. The MAC may have a function of performing error correction through a Hybrid Automatic Repeat reQuest (HARQ). The MAC may have a function of reporting scheduling information. The MAC may have a function of performing priority processing among the terminal apparatuses by using dynamic scheduling. The MAC may have a function of performing priority processing among the logical channels in one terminal apparatus. The MAC may have a function of performing priority processing of resources overlapping in one terminal apparatus. The E-UTRA MAC may have a function of identifying Multimedia Broadcast Multicast Services (MBMS). The NR MAC may have a function of identifying a Multicast Broadcast Service (MBS). The MAC may have a function of selecting a transport format. The MAC may have a function of performing Discontinuous Reception (DRX) and/or Discontinuous Transmission (DTX), a function of performing a Random Access (RA) procedure, a Power Headroom Report (PHR) function of reporting information of transmittable power, a Buffer Status Report (BSR) function of reporting data volume information of a transmission buffer, and the like. The NR MAC may have a Bandwidth Adaptation (BA) function. A MAC PDU format used in the E-UTRA MAC and a MAC PDU format used in the NR MAC may be different from each other. The MAC PDU may include a MAC control element (MAC CE) being an element for performing control in the MAC.

The MAC sublayer may additionally provide, on the PC5 interface, services and functions, such as radio resource selection for selecting a radio resource for sidelink transmission, filtering of packets received through sidelink communication, priority processing between the uplink and the sidelink, reporting of Sidelink Channel State Information (Sidelink CSI).

Mapping, which is used in E-UTRA and/or NR, between a sidelink (SL) logical channel and a sidelink logical channel and a transport channel will be described.

A Sidelink Broadcast Control Channel (SBCCH) may be a sidelink logical channel for broadcasting sidelink system information from one terminal apparatus to one or multiple terminal apparatuses. The SBCCH may be mapped to an SL-BCH that is a sidelink transport channel.

A Sidelink Control Channel (SCCH) may be a sidelink logical channel for transmitting control information such as a PC5-RRC message and a PC5-S message from one terminal apparatus to one or multiple terminal apparatuses. The SCCH may be mapped to an SL-SCH that is a sidelink transport channel.

A Sidelink Traffic Control Channel (STCH) may be a sidelink logical channel for transmitting user information from one terminal apparatus to one or multiple terminal apparatuses. The STCH may be mapped to the SL-SCH that is a sidelink transport channel.

An example of a function of the RLC will be described. The RLC may be referred to as an RLC sublayer. The E-UTRA RLC may have a function of segmenting (Segmentation) and/or concatenating (Concatenation) data provided from the PDCP of a higher layer, and providing the segmented and/or concatenated data to a lower layer. The E-UTRA RLC may have a function of reassembling (reassembly) and re-ordering data provided from a lower layer, and providing the reassembled and re-ordered data to a higher layer. The NR RLC may have a function of assigning data provided from the PDCP of a higher layer with a sequence number independent of a sequence number assigned in the PDCP. The NR RLC may have a function of segmenting (Segmentation) data provided from the PDCP and providing the segmented data to a lower layer. The NR RLC may have a function of reassembling (reassembly) data provided from a lower layer, and providing the reassembled data to a higher layer. The RLC may have a data retransmission function and/or retransmission request function (AutomaticRepeat reQuest (ARQ)). The RLC may have a function of performing error correction using the ARQ. Control information that indicates data required to be retransmitted and that is transmitted from a receiving side to a transmitting side of the RLC in order to perform the ARQ may be referred to as a status report. A status report transmission indication transmitted from the transmitting side to the receiving side of the RLC may be referred to as a poll. The RLC may have a function of detecting data duplication. The RLC may have a function of discarding data. The RLC may have three modes, namely a Transparent Mode (TM), an Unacknowledged Mode (UM), and an Acknowledged Mode (AM). In the TM, segmentation of data received from a higher layer need not be performed, and addition of an RLC header need not be performed. A TM RLC entity may be a uni-directional entity, and may be configured as a transmitting TM RLC entity or as a receiving TM RLC entity. In the UM, segmentation and/or concatenation of data received from a higher layer, addition of an RLC header, and the like may be performed, but retransmission control of data need not be performed. A UM RLC entity may be a uni-directional entity, or may be a bi-directional entity. In a case that the UM RLC entity is a uni-directional entity, the UM RLC entity may be configured as a transmitting UM RLC entity or as a receiving UM RLC entity. In a case that the UM RLC entity is a bi-directional entity, the UM RRC entity may be configured as a UM RLC entity including a transmitting side and a receiving side. In the AM, segmentation and/or concatenation of data received from a higher layer, addition of an RLC header, retransmission control of data, and the like may be performed. An AM RLC entity may be a bi-directional entity, and may be configured as an AM RLC including a transmitting side and a receiving side. Note that data provided to a lower layer and/or data provided from a lower layer in the TM may be referred to as a TMD PDU. Data provided to a lower layer and/or data provided from a lower layer in the UM may be referred to as a UMD PDU. Data provided to a lower layer or data provided from a lower layer in the AM may be referred to as an AMD PDU. An RLC PDU format used in the E-UTRA RLC and an RLC PDU format used in the NR RLC may be different from each other. The RLC PDU may include an RLC PDU for data and an RLC PDU for control. The RLC PDU for data may be referred to as an RLC DATA PDU (RLC Data PDU, RLC data PDU). Further, the RLC PDU for control may be referred to as an RLC CONTROL PDU (RLC Control PDU, RLC control PDU). A control RLC PDU used for transmission of the status report may be referred to as a status PDU (STATUS PDU).

Note that, in the sidelink, the TM may be used for the SBCCH, only the UM is used in groupcast transmission and broadcast transmission, and the UM and the AM can be used in unicast transmission. In the sidelink, the UM in groupcast transmission and broadcast transmission supports only unidirectional transmission.

An example of a function of the PDCP will be described. The PDCP may be referred to as a PDCP sublayer. The PDCP may have a function of maintenance of the sequence number. The PDCP may have a header compression and decompression function for efficiently transmitting, in wireless sections, user data such as an IP Packet and an Ethernet frame. A protocol used for header compression and decompression for an IP packet may be referred to as a Robust Header Compression (ROHC) protocol. A protocol used for header compression and decompression for an Ethernet frame may be referred to as an Ethernet (trade name) Header Compression (EHC) protocol. The PDCP may have a function of encrypting and decrypting data. The PDCP may have a function of data integrity protection and integrity verification. The PDCP may have a function of re-ordering. The PDCP may have a function of retransmitting the PDCP SDU. The PDCP may have a function of discarding data using a discard timer. The PDCP may have a Duplication function. The PDCP may have a function of discarding pieces of data received in a duplicate manner. The PDCP entity may be a bi-directional entity, and may include a transmitting PDCP entity and a receiving PDCP entity. A PDCP PDU format used in the E-UTRA PDCP and a PDCP PDU format used in the NR PDCP may be different from each other. The PDCP PDU may include a PDCP PDU for data and a PDCP PDU for control. The PDCP PDU for data may be referred to as a PDCP DATA PDU (PDCP Data PDU, PDCP data PDU). The PDCP PDU for control may be referred to as a PDCP CONTROL PDU (PDCP Control PDU, PDCP control PDU).

Note that, in the sidelink, there are the following restrictions on the functions and services of the PDCP.
(1) Out-of-order delivery may be supported exclusively in unicast transmission.
(2) Duplication on the PC5 interface is not supported.

An example of a function of the SDAP will be described. The SDAP is a service data adaptation protocol layer. In the sidelink, SDAP may have a function of mapping a sidelink QoS flow (PC5 QoS flow) sent from a terminal apparatus to another terminal apparatus with a sidelink data radio bearer (SL-DRB). The SDAP may also have a function of storing mapping rule information. The SDAP may also have a function of marking a QoS flow identifier (QoS Flow ID: QFI) and a PC5 QoS flow identifier (PC5 QoS Flow ID: PQFI or PFI). The SDAP PDU may include a data SDAP PDU and a control SDAP PDU. The SDAP PDU for data may be referred to as an SDAP DATA PDU (SDAP Data PDU, SDAP data PDU). The SDAP PDU for control may be referred to as an SDAP CONTROL PDU (SDAP Control PDU, SDAP control PDU). In the sidelink, one SDAP entity of the terminal apparatus may exist for each destination for unicast transmission, groupcast transmission, and broadcast transmission associated with a destination. Reflective QoS is not supported on the PC5 interface.

An example of a function of the RRC will be described. RRC may support services and functions on the PC5 interface such as forwarding of PC5-RRC messages between peer UEs, maintenance and release of the PC5-RRC connection between two UEs, and detection of a failure in sidelink radio link for PC5-RRC connection. The PC5-RRC connection is considered to be a logical connection between two UEs corresponding to a pair of a source L2ID and a destination L2ID and to be established after a corresponding PC5 unicast link is established. There is a one-to-one correspondence between the PC5-RRC connection and the PC5 unicast link. The UE may have multiple PC5-RRC connections to one or multiple UEs for different pairs of source L2IDs and destination L2IDs. A separate PC5-RRC procedure and separate messages may be used for the UE to transfer UE capabilities and sidelink configurations to peer UE. Both peer UEs may exchange the UE capabilities and sidelink configurations thereof with each other using a separate bi-directional procedure. In a case of being uninterested in the sidelink transmission, the UE releases the PC5-RRC connection in a case that a failure in sidelink radio link for the PC5-RRC connection is detected and that the Layer-2 link release procedure is completed.

A terminal apparatus capable of sidelink communication may perform discovery.

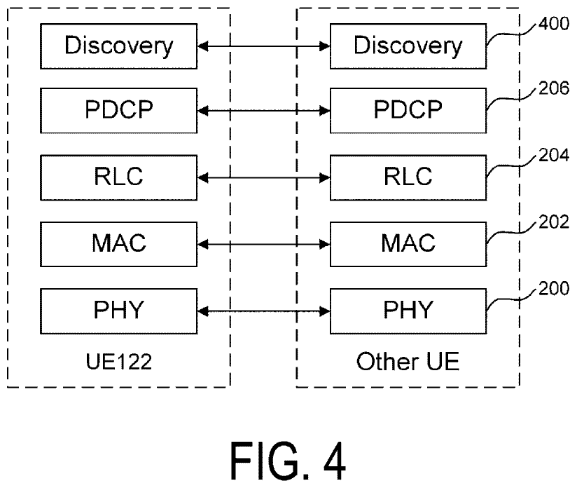

Discovery may include Model A and Model B. FIG. 4 shows a protocol stack in the discovery procedure. Model A may use a single discovery protocol message, and Model B may use two discovery protocol messages. The single discovery protocol message in Model A may be an Announcement message, and the discovery protocol message in Model B may include a Solicitation message and a Response message. The announcement message, solicitation message, and response message may be collectively referred to as a discovery message, and a message with another name used in the discovery procedure may be referred to as a discovery message. Hereinafter, an overview of procedures of Model A and Model B in ProSe Direct Discovery will be shown.

In Model A, a UE that transmits an announce message may be referred to as an Announcing UE, and a UE that monitors the announce message may be referred to as a Monitoring UE. The announce message may include information such as a discovery message type, a ProSe Application Code or a ProSe Restricted Code, a security protection element, and may additionally include metadata information. The announce message is transmitted using a Destination Layer-2 ID (destination L2ID) and a Source Layer-2 ID (source L2ID), and the monitoring UE determines the destination L2ID to receive the announce message. Note that the destination L2ID may be a Layer-2 identifier of the destination UE, and the source L2ID may be a Layer-2 identifier of the source UE. The destination UE may be simply referred to as a destination.

In Model B, a UE transmitting a solicitation message may be referred to as a discoverer UE, and a UE receiving the solicitation message and/or a UE transmitting a response message to the discoverer UE may be referred to as a discoveree UE. The solicitation message may include information such as a type of the discovery message, a ProSe Query Code, and a security protection element. The solicitation message is transmitted using the destination L2ID and the source L2ID, and the discoveree UE determines the destination L2ID to receive the solicitation message. The discoveree UE responding to the solicitation message transmits the response message. The response message may include information such as the discovery message type, a ProSe Response Code, and the security protection element, and may additionally include metadata information. The response message is transmitted using the source L2ID, and the destination L2ID is set to the source L2ID of the received solicitation message.

Discovery may include types other than ProSe Direct Discovery in which another UE is discovered in order to perform direct communication with the other UE, and may include Group member Discovery in which one or multiple UEs are discovered in order to perform communication within a group using a sidelink, 5G ProSe UE-to-Network Relay Discovery in which candidate relay UEs are discovered in order to connect to the network via a relay UE, and the like. Although the above-described discovery is an example of discovery provided by an application called ProSe, in addition to the above-described type, different types of discovery may be present according to an application or service for sidelink communication. Information included in the discovery protocol message may vary according to the type of discovery, and an additional message may be transmitted to transmit additional information.

FIG. 4 is a diagram of an example of a protocol architecture including the discovery protocol according to the present embodiment. As illustrated in FIG. 4, a protocol stack of a discovery plane including the discovery protocol may include the Physical layer (PHY) 200 which is a radio physical layer, the Medium Access Control (MAC) 202 which is a medium access control layer, the Radio Link Control (RLC) 204 which is a radio link control layer, a Packet Data Convergence Protocol (PDCP) 206 which is a packet data convergence protocol layer, and Discovery 400 which is a discovery protocol layer. The Discovery 400 may be a protocol used to handle procedures related to discovery. An interface between UEs performing discovery may be referred to as PC5-D.

A plurality of resource pools for transmitting a message (discovery message) used in a discovery procedure may be configured, or one or more resource pools dedicated to discovery may be configured. In a case that the resource pool dedicated to discovery is configured, the UE may use the resource pool dedicated to discovery for a resource pool for transmitting a discovery message, and in a case that a resource pool dedicated to discovery is not configured, the UE may use a resource pool for sidelink communication for a resource pool for transmitting a discovery message. Note that multiple resource pools for sidelink communication may be configured together with multiple dedicated resource pools for discovery. Each resource pool may be configured by dedicated signaling for UE or may be preconfigured.

In each unicast PC5-RRC connection, a signaling radio bearer (SRB) for sidelink may be configured. The SRB for sidelink used to transmit the PC5-S message before the PC5-S security is established may be referred to as SL-SRB0. The SRB for sidelink used to transmit the PC5-S message for establishing the PC5-S security may be referred to as SL-SRB1. Further, the sidelink SRB used to transmit a protected PC5-S message after PC5-S security is established may be referred to as SL-SRB2. Further, the sidelink SRB used to transmit a protected PC5-RRC signaling after the PC5-S security is established may be referred to as SL-SRB3. Further, the sidelink SRB used to transmit and/or receive a discovery message in the NR may be referred to as SL-SRB4. The PC5-RRC signaling may be RRC signaling between UEs transmitted and received on PC5. The PC5-RRC signaling may be referred to as a PC5-RRC message or the like.

Multi-path relay (multi-path relaying) will be described. The multi-path relay may be a technology in which the terminal apparatus communicates with the base station apparatus using two paths including a direct path and an indirect path. The direct path may be a path in which the terminal apparatus communicates directly with the base station apparatus via a Uu interface. The indirect path may be a path in which the terminal apparatus communicates with the base station apparatus via a relay terminal apparatus. The interface between the terminal apparatus and the relay terminal apparatus may be a PC5 interface or may be a different interface. In the multi-path relay, the terminal apparatus that connects to a base station apparatus using two paths including a direct path and an indirect path may be referred to as a multi-path remote terminal apparatus (MP remote UE), and a relay terminal apparatus that provides the multi-path remote terminal apparatus with a connection to the base station may be referred to as a multi-path relay terminal apparatus (MP relay UE). Also, the relay terminal apparatus may be a terminal apparatus that plays the role of a U2N relay UE. In a case that the PC5 interface is used as the interface between the multi-path remote terminal apparatus and the relay terminal apparatus, the multi-path relay terminal apparatus may be a terminal apparatus that plays the role of an L2 U2N relay UE, and the multi-path remote terminal apparatus may be a terminal apparatus that plays the role of an L2U2N remote UE. Further, in a case that a non-3GPP connection is used as the interface between the multi-path remote terminal apparatus and the relay terminal apparatus, the multi-path relay terminal apparatus may be a terminal apparatus that plays the role of a non-3GPP connection (N3C) relay UE, and the multi-path remote terminal apparatus may be a terminal apparatus that plays the role of an N3C remote UE. In the following description, the term “multi-path remote terminal apparatus” may be used without distinguishing between the N3C remote UE and the L2 U2N remote UE, and the term “multi-path relay terminal apparatus” may be used without distinguishing between the N3C relay UE and the L2 U2N relay UE.

In the multi-path relay, a bearer mapped to the direct path may be called a direct bearer, a bearer mapped to the indirect path may be called an indirect bearer, and a bearer mapped to both the direct path and the indirect path may be called a multi-path split bearer (MP split bearer), or simply a split bearer.

In the multi-path split bearer, an RLC channel for the Uu interface and an RLC channel for the indirect path may be configured for a PDCP entity of the terminal apparatus having the two paths including the direct path and the indirect path. Also, in a case that the interface between the terminal apparatus and the relay terminal apparatus in the indirect path is a PC5 interface, the RLC channel for the indirect path may be an RLC channel for the PC5 interface. In a case that PDCP duplication is configured for the multi-path split bearer and the PDCP duplication is activated, the PDCP entity may duplicate a PDCP DATA PDU to be submitted to a lower layer and submit the data to both of the plurality of RLC channels configured for the PDCP entity. The multi-path split bearer may be referred to as a bearer on which the multi-path split bearer is configured. The multi-path split bearer may be configured as either a data radio bearer or a signaling radio bearer. Further, in a case that the PDCP replication is not configured for the bearer on which the split bearer is configured (or the PDCP replication is configured but not activated) and a preferred path is configured, the PDCP DATA PDU may be submitted to a primary RLC entity configured for the preferred path, and in a case that a split secondary RLC entity is configured and the amount of data to be submitted to the primary RLC entity and the split secondary RLC entity is equal to or larger than a threshold, the PDCP DATA PDU may be submitted to either the primary RLC entity or the split secondary RLC entity.

Here, a UE-to-Network (U2N) relay used in communication in an indirect path will be described. The U2N relay may be a function of providing connectivity to a network to the remote terminal apparatus (remote UE). The remote terminal apparatus that connects to a network using a U2N relay may be referred to as a U2N remote UE. Further, a terminal apparatus that provides network connectivity to the U2N remote UE may be referred to as a U2N relay terminal apparatus (relay UE) or simply as a relay terminal apparatus (relay UE). The U2N relay UE may use the Uu interface for communication with the base station apparatus, or may use a PC5 interface for communication with the U2N remote UE. Further, there may be types of U2N relays, such as a layer 2 (L2) U2N relay and a layer 3 (L3) U2N relay. A remote terminal apparatus in the L2 U2N relay may be particularly referred to as an L2 U2N remote UE, and a relay terminal apparatus in the L2 U2N relay may be particularly referred to as an L2U2N relay UE. Also, in the L2 U2N relay, there may be SRAP (SRAP layer) 600 that is a sidelink relay adaptation protocol (SRAP) layer. The SRAP 600 may simply be expressed as SRAP.

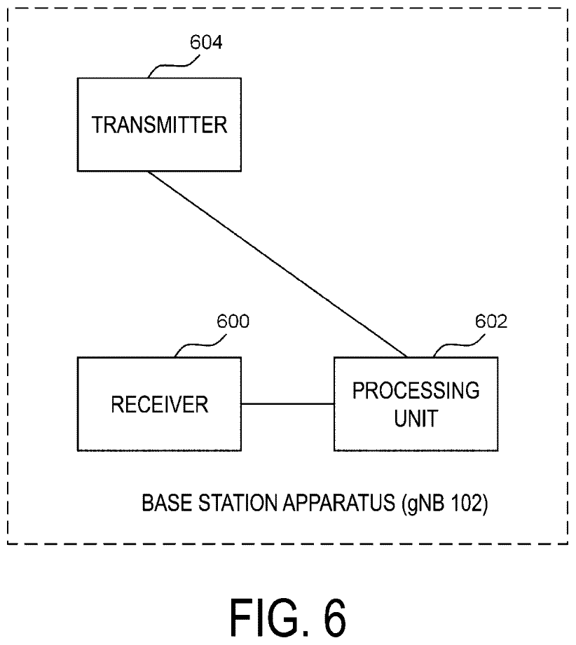

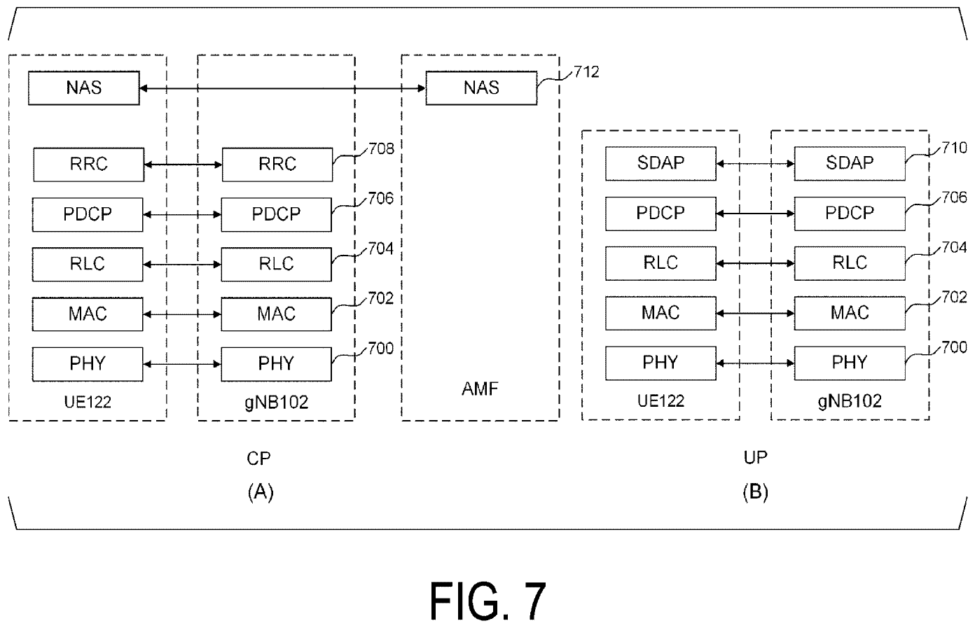

FIG. 6 is a diagram of an example of a protocol architecture of a control plane (C-plane) including the SRAP layer according to the present embodiment. Also, FIG. 7 is a diagram of an example of a protocol architecture of a user plane (U-plane) including the SRAP layer according to the present embodiment. As illustrated in FIGS. 6 and 7, the SRAP layer may be associated between the remote UE and the relay UE, and may be associated between the relay UE and the gNB 102. The gNB 102 illustrated in FIGS. 6 and 7 may be an ng-eNB 100. Also, the remote UE or relay UE may be a UE 122.

Here, the SRAP layer will be described. The SRAP layer may be called an SRAP sublayer, or simply SRAP. The SRAP sublayer may reside above an RLC sublayer for the control plane and user plane of both the PC5 interface and the Uu interface. The SRAP sublayer on the PC5 may be used for the purpose of bearer mapping. In an L2 U2N relay UE, the SRAP sublayer may include one SRAP entity on the Uu interface and a separate collocated SRAP entity on the PC5 interface. In the L2 U2N remote UE, the SRAP sublayer may include only one SRAP entity on the PC5 interface. The SRAP entity associated between the remote UE and the relay UE via the PC5 interface may be particularly referred to as a PC5-SRAP, and the SRAP entity associated between the relay UE and the gNB via the Uu may be particularly referred to as a Uu-SRAP. Further, in a case that an interface name is clarified, other entities may also be expressed in a format such as (interface name)-(entity name), similar to SRAP. Each SRAP entity may have a transmitter and a receiver. On the PC5 interface, the transmitter of the SRAP entity of the L2 U2N remote UE may be associated with the receiver of the SRAP entity of the L2 U2N relay UE, and the receiver of the SRAP entity of the L2 U2N remote UE may be associated with the transmitter of the SRAP entity of the L2 U2N relay UE. Also, on the Uu interface, the transmitter of the SRAP entity of the L2 U2N relay UE may be associated with the receiver of the SRAP entity of the gNB 102, and the receiver of the SRAP entity of the L2 U2N relay UE may be associated with the transmitter of the SRAP entity of the gNB 102.

Further, the SRAP entity may have a function of transferring data, a function of determining a UE ID field and a bearer ID field of an SRAP header to be added to a data packet, a function of determining an egress link, and a function of determining an egress RLC channel.

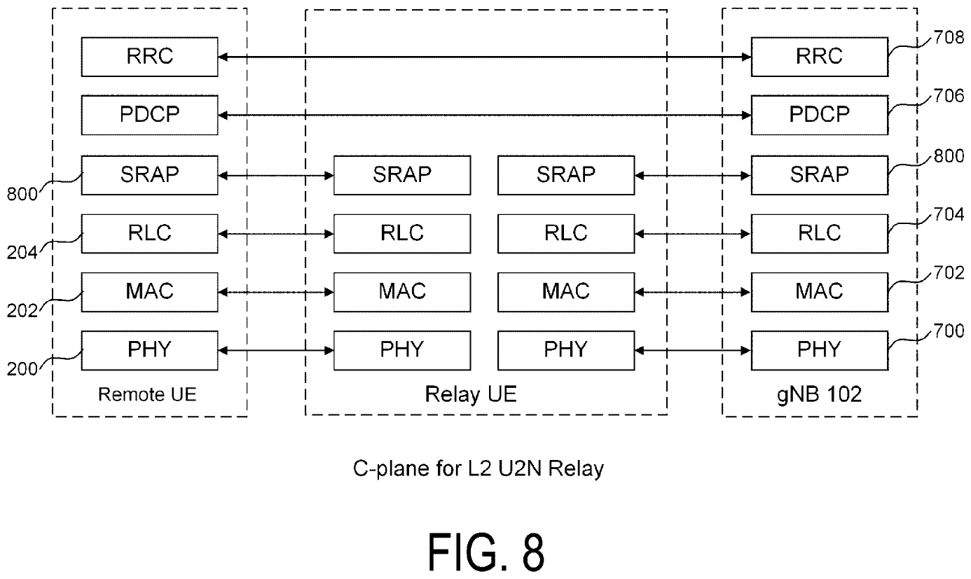

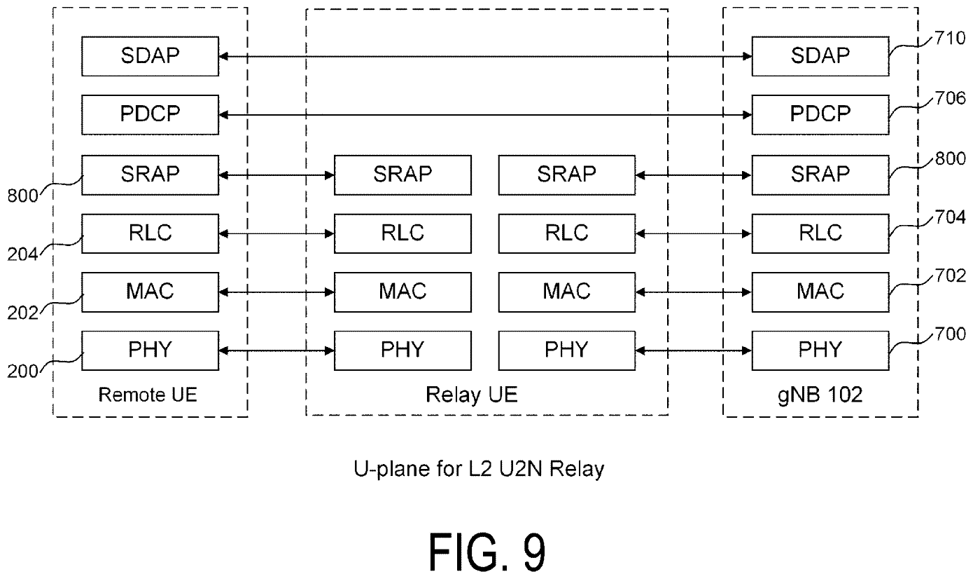

Further, in FIGS. 8 and 9, a PC5 relay RLC channel may be configured between the remote UE and the relay UE, and a Uu relay RLC channel may be configured between the relay UE and the gNB 102.

Next, a protocol architecture used between the base station apparatus and the terminal apparatus will be described. In communication performed at the Uu interface between the terminal apparatus and the base station apparatus, that is, communication in the direct path, communication performed via the relay terminal apparatus configured for the indirect path, and communication performed at the Uu interface between the relay terminal apparatus and the base station apparatus, a protocol used between the base station apparatus and the terminal apparatus may be used. In communication performed between the remote terminal apparatus and the base station apparatus via the relay terminal apparatus, some protocols need not be associated between the remote terminal apparatus and the base station apparatus.

FIG. 7 is a diagram of an example of the NR protocol architecture according to the present embodiment. Functions of each protocol described using FIG. 7 are only some functions closely according to the present embodiment, and each protocol may have other functions. Note that in the present embodiment, the uplink (UL) may be a link from the terminal apparatus to the base station apparatus. In the present embodiment, a downlink (DL) may be a link from the base station apparatus to the terminal apparatus.

FIG. 7(A) is a diagram of an NR control plane (CP) protocol stack. As illustrated in FIG. 7(A), the NR CP protocol may be a protocol between the UE 122 and the gNB 102. That is, the NR CP protocol may be a protocol that is terminated at the gNB 102 on the network side. As illustrated in FIG. 7(A), the NR control plane protocol stack may include a physical layer (PHY) 700 which is a radio physical layer, medium access control (MAC) 702 which is a medium access control layer, an RLC 704 which is a radio link control layer, a packet data convergence protocol (PDCP) 706 which is a packet data convergence protocol layer, and a radio resource control (RRC) 708 which is a radio resource control layer. Also, FIG. 7(B) is a diagram of an NR user plane (UP) protocol stack. As illustrated in FIG. 7(B), the NR UP protocol may be a protocol between the UE 122 and the gNB 102. That is, the NR UP protocol may be a protocol that is terminated at the gNB 102 on the network side. As illustrated in FIG. 7(B), the NR user plane protocol stack may include a PHY 700 which is a wireless physical layer, a MAC 702 which is a medium access control layer, an RLC 704 which is a radio link control layer, a PDCP 706 which is a packet data convergence protocol layer, and a service data adaptation protocol (SDAP) 710 which is a service data adaptation protocol layer.

An access stratum (AS) layer may be a layer that is terminated between the UE 122 and the gNB 102. That is, the AS layer may be a layer that includes some or all of the PHY 700, MAC 702, RLC 704, PDCP 706, and RRC 708. The gNB 102 may also be an ng-eNB 100. Although only the NR protocol is shown, the E-UTRA protocol may also be used. In the E-UTRA protocol, the SDAP 710 need not exist, and the E-UTRA protocol may have some functions different from those of the NR protocol.

Note that in the present embodiment, hereinafter, the E-UTRA protocol and the NR protocol need not be distinguished from each other, and the terms PHY (PHY layer), MAC (MAC layer), RLC (RLC layer), PDCP (PDCP layer), and RRC (RRC layer) may be used. In this case, the PHY (PHY layer), MAC (MAC layer), RLC (RLC layer), PDCP (PDCP layer), and RRC (RRC layer) may be the PHY (PHY layer), MAC (MAC layer), RLC (RLC layer), PDCP (PDCP layer), and RRC (RRC layer) of the E-UTRA protocol, respectively, or may be the PHY (PHY layer), MAC (MAC layer), RLC (RLC layer), PDCP (PDCP layer), and RRC (RRC layer) of the NR protocol, respectively. Also, the SDAP (SDAP layer) may be the SDAP (SDAP layer) of the NR protocol.

Further, in the present embodiment, hereinafter, in a case that the protocol for E-UTRA and the protocol for NR are distinguished from each other the PHY 500, MAC 502, RLC 504, PDCP 506, and RRC 508 may be referred to as PHY for E-UTRA or PHY for LTE, MAC for E-UTRA or MAC for LTE, RLC for E-UTRA or RLC for LTE, PDCP for E-UTRA or PDCP for LTE, and RRC for E-UTRA or RRC for LTE, respectively. Further, the PHY 500, the MAC 502, the RLC 504, the PDCP 506, and the RRC 508 may be described as, for example, E-UTRA PHY or LTE PHY, E-UTRA MAC or LTE MAC, E-UTRA RLC or LTE RLC, E-UTRA PDCP or LTE PDCP, and E-UTRA RRC or LTE RRC. Further, in a case that the E-UTRA protocol and the NR protocol are distinguished from each other, the PHY 500, the MAC 502, the RLC 504, the PDCP 506, and the RRC 508 may be referred to as PHY for NR, MAC for NR, RLC for NR, RLC for NR, and RRC for NR, respectively. Also, the PHY 500, MAC 502, RLC 504, PDCP 506, and RRC 508 may be described as, for example, NR PHY, NR MAC, NR RLC, NR PDCP, and NR RRC, respectively.

Entities in the AS layer of E-UTRA and/or NR will be described. An entity having a part or all of functions of the physical layer may be referred to as a PHY entity. An entity having a part or all of functions of the MAC layer may be referred to as a MAC entity. An entity having a part or all of functions of the RLC layer may be referred to as an RLC entity. An entity having a part or all of functions of the PDCP layer may be referred to as a PDCP entity. An entity having a part or all of functions of the SDAP layer may be referred to as an SDAP entity. An entity having a part or all of functions of the RRC layer may be referred to as an RRC entity. The PHY entity, the MAC entity, the RLC entity, the PDCP entity, the SDAP entity, and the RRC entity may respectively be replaced with a PHY, a MAC, an RLC, a PDCP, an SDAP, and an RRC.

Data provided from the MAC, the RLC, the PDCP, and the SDAP to a lower layer, and/or data provided from the lower layer to the MAC, the RLC, the PDCP, and the SDAP may be referred to as a MAC protocol data unit (PDU), an RLC PDU, a PDCP PDU, and an SDAP PDU, respectively. Data provided to the MAC, the RLC, the PDCP, and the SDAP from a higher layer, and/or data provided from the MAC, the RLC, the PDCP, and the SDAP to a higher layer may be referred to as a MAC Service Data Unit (SDU), an RLC SDU, a PDCP SDU, and an SDAP SDU, respectively. A segmented RLC SDU may be referred to as an RLC SDU segment.

Here, the base station apparatus and the terminal apparatus exchange (transmit and/or receive) signals with each other in a higher layer. The higher layer may be referred to as an upper layer, and may be paraphrased with each other. For example, the base station apparatus and the terminal apparatus may transmit and/or receive an RRC message (also referred to as RRC signaling) in the Radio Resource Control (RRC) layer. Further, the base station apparatus and the terminal apparatus may transmit and/or receive a MAC control element in a medium access control (MAC) layer. Further, the RRC layer of the terminal apparatus acquires system information broadcast from the base station apparatus. Here, the RRC message, the system information, and/or the MAC control element are also referred to as higher layer signaling or a higher layer parameter. Each of the parameters included in the higher layer signaling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, an RLC layer, a PDCP layer, a Non Access Stratum (NAS) layer, and the like. For example, in the processing of the MAC layer, the higher layer may mean one or multiple of the RRC layer, the RLC layer, the PDCP layer, the NAS layer, and the like.

Hereinafter, the meaning of “A is given (provided) by a higher layer” or “A is given (provided) by a higher layer” may mean that a higher layer (mainly an RRC layer, a MAC layer, or the like) of the terminal apparatus receives A from the base station apparatus, and the received A is given (provided) to the physical layer of the terminal apparatus by the higher layer of the terminal apparatus. For example, “a higher layer parameter being provided” in the terminal apparatus may mean that higher layer signaling is received from the base station apparatus, and a higher layer parameter included in the received higher layer signaling is provided from the higher layer of the terminal apparatus to the physical layer of the terminal apparatus. A higher layer parameter being configured for the terminal apparatus may mean that the higher layer parameter is given (provided) to the terminal apparatus. For example, a higher layer parameter being configured for the terminal apparatus may mean that the terminal apparatus receives higher layer signaling from the base station apparatus and configures the received higher layer parameter in the higher layer. However, a higher layer parameter being configured for the terminal apparatus may include a default parameter given in advance being configured in the higher layer of the terminal apparatus. In description of transmission of an RRC message from the terminal apparatus to the base station apparatus, the expression that a message is submitted from the RRC entity of the terminal apparatus to a lower layer may be used. In the terminal apparatus, “submitting a message to a lower layer” from the RRC entity may mean submitting a message to the PDCP layer. In the terminal apparatus, “submitting a message to a lower layer” from the RRC layer may mean to submitting the message of the RRC to a PDCP entity corresponding to each SRB (SRB0, SRB1, SRB2, SRB3, or the like) because the message is transmitted using the SRB. In a case that the RRC entity of the terminal apparatus receives an indication from a lower layer, the lower layer may mean one or more of a PHY layer, a MAC layer, an RLC layer, a PDCP layer, and the like.

An example of a function of the PHY will be described. The PHY of the terminal apparatus may have a function of receiving data transmitted from the PHY of the base station apparatus via a Downlink (DL) Physical Channel. The PHY of the terminal apparatus may have a function of transmitting data to the PHY of the base station apparatus via an Uplink (UL) physical channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Here, the physical channels will be described. Physical channels used for radio communication between the terminal apparatus and the base station apparatus may include the following physical channels.
Physical Broadcast CHannel (PBCH)
Physical Downlink Control CHannel (PDCCH)
Physical Downlink Shared CHannel (PDSCH)
Physical Uplink Control CHannel (PUCCH)
Physical Uplink Shared CHannel (PUSCH)
Physical Random Access CHannel (PRACH)

The PBCH may be used to broadcast system information required by the terminal apparatus.

Further, in the NR, the PBCH may be used to broadcast a time index (SSB-Index) within a period of a synchronization signal block (SSB).

The PDCCH may be used to transmit (or carry) Downlink Control Information (DCI) in downlink radio communication (radio communication from the base station apparatus to the terminal apparatus). Here, one or multiple pieces of DCI (which may be referred to as DCI formats) may be defined for transmission of the downlink control information. In other words, a field for the downlink control information may be defined as DCI and may be mapped to information bits. The PDCCH may be transmitted in PDCCH candidates. The terminal apparatus may monitor a set of PDCCH candidates in a serving cell. To monitor a set of PDCCH candidates may mean an attempt to decode the PDCCH in accordance with a certain DCI format. Further, the terminal apparatus may monitor the PDCCH candidates in monitoring occasions configured in one or a plurality of configured control resource sets (CORESETs) configured by a search space configuration. The DCI format may be used for scheduling of the PUSCH in the serving cell. The PUSCH may be used for transmission of user data, transmission of RRC messages to be described below, and the like.

PDCCH repetition may be operated by using two search space sets that are explicitly linked by a configuration provided by a higher layer (RRC layer). Further, the two linked search space sets may be associated with a corresponding CORESET. For the PDCCH repetition, the two linked search space sets may be configured in the terminal apparatus with the same number of PDCCH candidates. The two PDCCH candidates present in the two linked search space sets may be linked by the same candidate index. In a case that the PDCCH repetition is scheduled in the terminal apparatus, inter-slot repetition may be allowed, and each repetition may have the same number of Control Channel Elements (CCEs) and coded bits, and the same DCI payload.

The PUCCH may be used to transmit uplink control information (UCI) in uplink wireless communication (wireless communication from a terminal apparatus to a base station apparatus). Here, the uplink control information may include channel state information (CSI) that is used to indicate a state of a downlink channel. Further, the uplink control information may include a scheduling request (SR) that is used to request UL-SCH (UL-SCH: Uplink Shared CHannel) resources. The uplink control information may include a Hybrid Automatic Repeat reQuest ACKnowledgement (HARQ-ACK).

The PDSCH may be used to transmit downlink data (DL-SCH: Downlink Shared CHannel) from the MAC layer. In a case of the downlink, the PDSCH may be used to transmit System Information (SI), a Random Access Response (RAR), and the like.

The PUSCH may be used to transmit uplink data from the MAC layer (UL-SCH: Uplink Shared CHannel) or HARQ-ACK and/or CSI together with the uplink data. The PUSCH may be used to transmit CSI only or a HARQ-ACK and CSI only. In other words, the PUSCH may be used to transmit the UCI only. Further, the PDSCH or PUSCH may be used to transmit an RRC message and a MAC CE, which will be described later. Here, in the PDSCH, the RRC message transmitted from the base station apparatus may be common signaling for a plurality of terminal apparatuses in a cell. Further, the RRC message transmitted from the base station apparatus may be dedicated signaling for a certain terminal apparatus. That is, terminal apparatus-specific (UE specific) information may be transmitted using dedicated signaling for a certain terminal apparatus. Further, the PUSCH may be used to transmit UE capability in the uplink.

The PRACH may be used to transmit a random access preamble. The PRACH may be used to indicate an initial connection establishment procedure, a handover procedure, a connection reestablishment procedure, synchronization (timing adjustment) for uplink transmission, and a request for a UL-SCH resource.

An example of a function of the MAC will be described. The MAC may be referred to as a MAC sublayer. The MAC may have a function of mapping various Logical Channels to their corresponding transport channels. The logical channel may be identified with a Logical Channel Identity (or Logical Channel ID). The MAC may be connected to an upper RLC with a logical channel. The logical channel may be classified into a control channel for transmitting control information and a traffic channel for transmitting user information depending on the type of information to be transmitted. The logical channel may be classified into an uplink logical channel and a downlink logical channel. The MAC may have a function of multiplexing MAC SDUs belonging to one or multiple different logical channels and providing the multiplexed MAC SDUs to the PHY. The MAC may have a function of demultiplexing the MAC PDUs provided from the PHY and providing the demultiplexed MAC PDUs to a higher layer via the logical channels to which the respective MAC SDUs belong. The MAC may have a function of performing error correction through a Hybrid Automatic Repeat reQuest (HARQ). The MAC may have a function of reporting scheduling information. The MAC may have a function of performing priority processing among the terminal apparatuses by using dynamic scheduling. The MAC may have a function of performing priority processing among the logical channels in one terminal apparatus. The MAC may have a function of performing priority processing of resources overlapping in one terminal apparatus. The E-UTRA MAC may have a function of identifying Multimedia Broadcast Multicast Services (MBMS). The NR MAC may have a function of identifying a Multicast Broadcast Service (MBS). The MAC may have a function of selecting a transport format. The MAC may have a function of performing Discontinuous Reception (DRX) and/or Discontinuous Transmission (DTX), a function of performing a Random Access (RA) procedure, a Power Headroom Report (PHR) function of reporting information of transmittable power, a Buffer Status Report (BSR) function of reporting data volume information of a transmission buffer, and the like. The NR MAC may have a bandwidth adaptation (BA) function. Further, a MAC PDU format used in the E-UTRA MAC and a MAC PDU format used in the NR MAC may be different from each other. The MAC PDU may include a MAC control element (MAC CE) that is an element for performing control in the MAC.

Uplink (UL) and/or downlink (DL) logical channels used in E-UTRA and/or NR will be described.

The broadcast control channel (BCCH) may be a downlink logical channel for broadcasting control information such as system information (SI).

A paging control channel (PCCH) may be a downlink logical channel for carrying a paging message.

A common control channel (CCCH) may be a logical channel for transmitting control information between the terminal apparatus and the base station apparatus. The CCCH may be used in a case that the terminal apparatus does not have RRC connection. The CCCH may be used between the base station apparatus and multiple terminal apparatuses.

A dedicated control channel (DCCH) may be a logical channel for transmitting dedicated control information in a point-to-point bi-directional manner between the terminal apparatus and the base station apparatus. The dedicated control information may be control information dedicated to each terminal apparatus. The DCCH may be used in a case that the terminal apparatus has RRC connection.

A dedicated traffic channel (DTCH) may be a logical channel for transmitting user data in a point-to-point manner between the terminal apparatus and the base station apparatus. The DTCH may be a logical channel for transmitting dedicated user data. The dedicated user data may be user data dedicated to each terminal apparatus. The DTCH may be present in both of the uplink and the downlink.

Mapping of the logical channels and the transport channel for the uplink in E-UTRA and/or NR will be described.

The CCCH may be mapped to an uplink shared channel (UL-SCH), which is an uplink transport channel.

The DCCH may be mapped to an uplink shared channel (UL-SCH), which is an uplink transport channel.

The DTCH may be mapped to the UL-SCH (Uplink Shared Channel), which is an uplink transport channel.

Mapping of the logical channel and the transport channel in the downlink in E-UTRA and/or NR will be described.

The BCCH may be mapped to the broadcast channel (BCH), which is a downlink transport channel, and/or the downlink shared channel (DL-SCH).

The PCCH may be mapped to a paging channel (PCH), which is a downlink transport channel.

The CCCH may be mapped to a downlink shared channel (DL-SCH), which is a downlink transport channel.

The DCCH may be mapped to a downlink shared channel (DL-SCH), which is a downlink transport channel.

The DTCH may be mapped to a downlink shared channel (DL-SCH), which is a downlink transport channel.

An example of a function of the RLC will be described. The RLC may be referred to as an RLC sublayer. The E-UTRA RLC may have a function of segmenting (Segmentation) and/or concatenating (Concatenation) data provided from the PDCP of a higher layer, and providing the segmented and/or concatenated data to a lower layer. The E-UTRA RLC may have a function of reassembling (reassembly) and re-ordering data provided from a lower layer, and providing the reassembled and re-ordered data to a higher layer. The NR RLC may have a function of assigning data provided from the PDCP of a higher layer with a sequence number independent of a sequence number assigned in the PDCP. The NR RLC may have a function of segmenting (Segmentation) data provided from the PDCP and providing the segmented data to a lower layer. The NR RLC may have a function of reassembling (reassembly) data provided from a lower layer, and providing the reassembled data to a higher layer. The RLC may have a data retransmission function and/or retransmission request function (AutomaticRepeat reQuest (ARQ)). The RLC may have a function of performing error correction using the ARQ. Control information that indicates data required to be retransmitted and that is transmitted from a receiving side to a transmitting side of the RLC in order to perform the ARQ may be referred to as a status report. A status report transmission indication transmitted from the transmitting side to the receiving side of the RLC may be referred to as a poll. The RLC may have a function of detecting data duplication. The RLC may have a function of discarding data. The RLC may have three modes, namely a Transparent Mode (TM), an Unacknowledged Mode (UM), and an Acknowledged Mode (AM). In the TM, segmentation of data received from a higher layer need not be performed, and addition of an RLC header need not be performed. A TM RLC entity may be a uni-directional entity, and may be configured as a transmitting TM RLC entity or as a receiving TM RLC entity. In the UM, segmentation and/or concatenation of data received from a higher layer, addition of an RLC header, and the like may be performed, but retransmission control of data need not be performed. A UM RLC entity may be a uni-directional entity, or may be a bi-directional entity. In a case that the UM RLC entity is a uni-directional entity, the UM RLC entity may be configured as a transmitting UM RLC entity or as a receiving UM RLC entity. In a case that the UM RLC entity is a bi-directional entity, the UM RRC entity may be configured as a UM RLC entity including a transmitting side and a receiving side. In the AM, segmentation and/or concatenation of data received from a higher layer, addition of an RLC header, retransmission control of data, and the like may be performed. An AM RLC entity may be a bi-directional entity, and may be configured as an AM RLC including a transmitting side and a receiving side. Note that data provided to a lower layer and/or data provided from a lower layer in the TM may be referred to as a TMD PDU. Data provided to a lower layer and/or data provided from a lower layer in the UM may be referred to as a UMD PDU. Data provided to a lower layer or data provided from a lower layer in the AM may be referred to as an AMD PDU. An RLC PDU format used in the E-UTRA RLC and an RLC PDU format used in the NR RLC may be different from each other. Further, the RLC PDU may include an RLC PDU for data and an RLC PDU for control. The RLC PDU for data may be referred to as an RLC DATA PDU (RLC Data PDU). Further, the RLC PDU for control may be referred to as an RLC CONTROL PDU (RLC Control PDU).

An example of a function of the PDCP will be described. The PDCP may be referred to as a PDCP sublayer. The PDCP may have a function of maintenance of the sequence number. The PDCP may have a header compression and decompression function for efficiently transmitting, in wireless sections, user data such as an IP Packet and an Ethernet frame. A protocol used for header compression and decompression for an IP packet may be referred to as a Robust Header Compression (ROHC) protocol. A protocol used for header compression and decompression for an Ethernet frame may be referred to as an Ethernet (trade name) Header Compression (EHC) protocol. The PDCP may have a function of encrypting and decrypting data. The PDCP may have a function of data integrity protection and integrity verification. The PDCP may have a function of re-ordering. The PDCP may have a function of retransmitting the PDCP SDU. The PDCP may have a function of discarding data using a discard timer. The PDCP may have a Duplication function. The PDCP may have a function of discarding pieces of data received in a duplicate manner. The PDCP entity may be a bi-directional entity, and may include a transmitting PDCP entity and a receiving PDCP entity. A PDCP PDU format used in the E-UTRA PDCP and a PDCP PDU format used in the NR PDCP may be different from each other. The PDCP PDU may include a PDCP PDU for data and a PDCP PDU for control. The PDCP PDU for data may be referred to as a PDCP DATA PDU (PDCP Data PDU, PDCP data PDU). The PDCP PDU for control may be referred to as a PDCP CONTROL PDU (PDCP Control PDU, PDCP control PDU).

An example of a function of the SDAP will be described. The SDAP is a service data adaptation protocol layer. The SDAP may have a function of performing association (mapping) of a downlink QoS flow sent from the 5GC to the terminal apparatus via the base station apparatus with a data radio bearer (DRB), and/or mapping of an uplink QoS flow sent from the terminal apparatus to the 5GC via the base station apparatus with the DRB. The SDAP may also have a function of storing mapping rule information. The SDAP may have a function of performing marking of a QoS flow identifier (QOS Flow ID (QFI)). Note that the SDAP PDU may include an SDAP PDU for data and an SDAP PDU for control. The SDAP PDU for data may be called an SDAP DATA PDU (SDAP Data PDU). Further, the SDAP PDU for control may be called an SDAP CONTROL PDU (SDAP control PDU). Note that, in the terminal apparatus, one SDAP entity may be present for one PDU session.

An example of a function of the RRC will be described. The RRC may have a broadcast function. The RRC may have a function of calling (paging) from the 5GC. The RRC may have a function of calling (paging) from the gNB 102 or ng-eNB 100. The RRC may also have an RRC connection management function. The RRC may have a radio bearer control function. The RRC may have a cell group control function. The RRC may have a mobility control function. Further, the RRC may have a terminal apparatus measurement reporting function and a terminal apparatus measurement reporting control function. Further, the RRC may have a QoS management function. Further, the RRC may have a radio link failure detection and recovery function. The RRC may perform broadcasting, paging, RRC connection management, radio bearer control, cell group control, mobility control, terminal apparatus measurement reporting and terminal apparatus measurement reporting control, QoS management, radio link failure detection and recovery, and the like by using the RRC message. Further, the RRC message and parameters used in the E-UTRA RRC may be different from the RRC message and parameters used in the NR RRC. Further, the RRC message may include a plurality of information elements (IEs) for performing the above-described control.

The RRC message may be sent using the BCCH of the logical channel, may be sent using the PCCH of the logical channel, may be sent using the CCCH of the logical channel, or may be sent using the DCCH of the logical channel. Further, the RRC message sent using the DCCH is called dedicated RRC signaling, or simply RRC signaling.

The RRC message sent using the BCCH may include, for example, a master information block (MIB), may include various types of system information blocks (SIBs), and may include other RRC messages. In the RRC message transmitted using the PCCH, for example, a paging message may be included, or another RRC message may be included.

The RRC message sent in an uplink (UL) direction using the CCCH may include, for example, an RRC setup request message (RRC Setup Request), an RRC resume request message (RRC Resume Request), an RRC reestablishment request message (RRC Reestablishment Request), an RRC system information request message (RRC System Info Request), and the like. For example, an RRC connection request message (RRC Connection Request), an RRC connection resume request message (RRC Connection Resume Request), an RRC connection reestablishment request message (RRC Connection Reestablishment Request), and the like may be included. Another RRC message may be included.

The RRC messages sent in a downlink (DL) direction using the CCCH may include, for example, an RRC connection reject message (RRC Connection Reject), an RRC connection setup message (RRC Connection Setup), an RRC connection reestablishment message (RRC Connection Reestablishment), an RRC connection reestablishment reject message (RRC Connection Reestablishment Reject), and the like. For example, an RRC reject message (RRC Reject), an RRC setup message (RRC Setup), and the like may be included. Another RRC message may be included.

The RRC signaling sent in the uplink (UL) direction using the DCCH includes, for example, a measurement report message (Measurement Report), an RRC connection reconfiguration complete message (RRC Connection Reconfiguration Complete), and an RRC connection setup complete message (RRC Connection Setup Complete), RRC connection reestablishment complete message (RRC Connection Reestablishment Complete), security mode complete message (Security Mode Complete), UE capability information message (UE Capability Information), and the like. For example, a measurement report message (Measurement Report), an RRC reconfiguration complete message (RRC Reconfiguration Complete), an RRC setup complete message (RRC Setup Complete), an RRC reestablishment complete message (RRC Reestablishment Complete), an RRC resume complete message (RRC Resume Complete), a security mode complete message (Security Mode Complete), a UE capability information message (UE Capability Information), and the like may be included. Another RRC signaling may be included.

The RRC signaling sent in the downlink (DL) direction using the DCCH may include, for example, an RRC connection reconfiguration message (RRC Connection Reconfiguration), an RRC connection release message (RRC Connection Release), and a security mode command message (Security Mode Command), UE capability inquiry message (UE Capability Inquiry), and the like. For example, an RRC reconfiguration message (RRC Reconfiguration), an RRC resume message (RRC Resume), an RRC release message (RRC Release), an RRC reestablishment message (RRC Reestablishment), a security mode command message (Security Mode Command), a UE capability enquiry message (UE Capability Enquiry), and the like may be included. Another RRC signaling may be included.

The functions of PHY, MAC, RLC, PDCP, SDAP, and RRC described above are examples, and some or all of the functions need not be implemented. Also, some or all of the functions of each layer may be included in other layers.

The radio bearers will be described. In a case that the terminal apparatus communicates with the base station apparatus, radio connection may be performed by establishing a Radio Bearer (RB) between the terminal apparatus and the base station apparatus. The radio bearer used for the CP may be referred to as a Signaling Radio Bearer (SRB). The radio bearer used for the UP may be referred to as a Data Radio Bearer (DRB). Each radio bearer may be assigned a radio bearer identity (Identity (ID)). The radio bearer identity for the SRB may be referred to as an SRB identity (SRB Identity or SRB ID). The radio bearer identity for the DRB may be referred to as a DRB identity (DRB Identity or DRB ID). For the SRBs of E-UTRA, SRB0 to SRB2 may be defined, or SRBs other than these may be defined. For the SRBs of NR, SRB0 to SRB3 may be defined, or SRBs other than these may be defined. SRB0 may be an SRB for an RRC message transmitted and/or received using the CCCH of the logical channel. SRB1 may be an SRB for RRC signaling, and for NAS signaling before establishment of SRB2. The RRC signaling transmitted and/or received using SRB1 may include a piggybacked NAS signaling. For all of RRC signaling and NAS signaling transmitted and/or received using SRB1, the DCCH of the logical channel may be used. SRB2 may be SRB for NAS signaling and for RRC signaling including logged measurement information. The DCCH of the logical channel may be used for all RRC signaling and NAS signaling transmitted and/or received using SRB2. SRB2 may also have a lower priority than SRB1. SRB3 may be an SRB for transmitting and/or receiving specific RRC signaling in a case that EN-DC, NGEN-DC, NR-DC, and the like are configured in the terminal apparatus. The DCCH of the logical channel may be used for all RRC signaling and NAS signaling transmitted and/or received using the SRB3. Other SRBs may also be provided for other purposes. The DRB may be a radio bearer for user data. The DTCH of the logical channel may be used for RRC signaling transmitted and/or received using the DRB.

The radio bearer in the terminal apparatus will be described. The radio bearers include an RLC bearer. The RLC bearer may include one or two RLC entities and a logical channel. The RLC entities in a case that there are two RLC entities in an RLC bearer may be a TM RLC entity and/or a transmitting RLC entity and a receiving RLC entity in a unidirectional UM mode RLC entity. SRB0 may include one RLC bearer. The RLC bearer of the SRB0 may include a TM RLC entity and a logical channel. SRB0 may be always established in a terminal apparatus in all states (RRC idle state, RRC connected state, RRC inactive state, and the like). SRB1 may be established and/or configured in the terminal apparatus by RRC signaling received from the base station apparatus in a case that the terminal apparatus transitions from the RRC idle state to the RRC connected state. SRB1 may include one PDCP entity and one or more RLC bearers. The RLC bearer of SRB1 may include an RLC entity of AM and a logical channel. SRB2 may be established and/or configured in the terminal apparatus by RRC signaling received from the base station apparatus by the terminal apparatus in the RRC connected state with AS security activated. SRB2 may include one PDCP entity and one or more RLC bearers. The RLC bearer of SRB2 may include the RLC entity of AM and the logical channel. The PDCP on the base station apparatus side of SRB1 and SRB2 may be placed in a master node. SRB3 may be established and/or configured in the terminal apparatus by RRC signaling received from the base station apparatus by the terminal apparatus in the RRC connected state with AS security activated in a case that a secondary node in EN-DC, NGEN-DC, or NR-DC is added or in a case that the secondary node is changed. SRB3 may be a direct SRB between the terminal apparatus and the secondary node. SRB3 may include one PDCP entity and one or more RLC bearers. The RLC bearer of SRB3 may include the RLC entity of the AM and the logical channel. The PDCP on the base station apparatus side of SRB3 may be placed in the secondary node. One or more DRBs may be established and/or configured in the terminal apparatus by RRC signaling received from the base station apparatus by the terminal apparatus in the RRC connected state with AS security activated. The DRB may include one PDCP entity and one or more RLC bearers. The RLC bearer of the DRB may include an AM or UM RLC entity and a logical channel.

For RLC bearers established and/or configured in a cell group configured with E-UTRA, the established and/or configured RLC entity may be an E-UTRA RLC. The RLC entity established and/or configured for the RLC bearer established and/or configured for the cell group configured in NR may be the NR RLC. In a case that EN-DC is configured in the terminal apparatus, the PDCP entity established and/or configured for a master node (MN) terminated MCG bearer may be either an E-UTRA PDCP or an NR PDCP. Further, in a case that EN-DC is configured in the terminal apparatus, the PDCP established and/or configured for radio bearers of other bearer types, that is, an MN terminated split bearer, an MN terminated SCG bearer, a secondary node (SN) terminated MCG bearer, an SN terminated split bearer, and an SN terminated SCG bearer, may be an NR PDCP. In a case that NGEN-DC, NE-DC, or NR-DC is configured in the terminal apparatus, the PDCP entity established and/or configured for radio bearers in all bearer types may be the NR PDCP.

In NR, the DRB established and/or configured in the terminal apparatus may be linked to one PDU session. One SDAP entity may be established and/or configured for one PDU session in the terminal apparatus. The SDAP entity, PDCP entity, RLC entity, and logical channels established and/or configured in the terminal apparatus may be established and/or configured by RRC signaling received by the terminal apparatus from the base station apparatus.

The reference signal received power (RSRP) measured in the sidelink may be, for example, the following RSRP. The following RSRP may be referred to as SL-RSRP.
(a) PSBCH RSRP
(b) PSSCH RSRP
(c) PSCCH RSRP

The PSBCH-RSRP (PSBCH RSRP) may be defined as a linear average of power contributions of resource elements that transmit a plurality of demodulation reference signals (DMRS) associated with the PSBCH. The PSSCH-RSRP (PSSCH RSRP) may be defined as a linear average of power contributions of resource elements of antenna ports transmitting multiple DMRSs associated with the PSSCH, and in a case that there are multiple antenna ports, values of RSRP for each antenna port may be summed. The PSCCH-RSRP (PSCCH RSRP) may be defined as a linear average of power contributions of resource elements carrying multiple DMRS associated with the PSCCH. Note that the DMRS may be used to demodulate, for example, signals of the PSBCH, the PSSCH, and the PSCCH. Further, a terminal apparatus performing sidelink communication with another terminal apparatus may measure the RSRP of the sidelink communication (SL-RSRP) using the PSSCH or PSCCH transmitted from the other terminal apparatus. Further, the terminal apparatus may measure the RSRP of the discovery message (SD-RSRP) using the power contributions of resource elements transmitting DMRS associated with the PSSCH carrying the discovery message.

Further, in measurements in the sidelink, the UE 122 may measure the following quantities in addition to the above-described RSRP.
(a) Sidelink received signal strength indicator (SL RSSI)
(b) Sidelink channel Occupancy ratio (SL CR)
(c) Sidelink channel busy ratio (SL CBR)

The SL RSSI may be defined as a linear average of the power ([W]) observed on configured subchannels in the OFDM symbols of slots configured for PSCCH and PSSCH, starting from a second OFDM symbol. Further, the SL CR in slot n may be defined as a sum of the number of subchannels used for sidelink transmission from slot [n-a] to slot [n-1] and the number of subchannels allocated from slot [n] to slot [n+b] divided by a total number of subchannels configured from slot [n-a] to slot [n+b]. Further, the SL CBR in slot n may be defined as a percentage of subchannels in the resource pool whose SL RSSI exceeds a threshold during a period configured as a CBR measurement window (slot [n-a] to slot [n-1]).

After discovering candidate L2 U2N Relay UEs and measuring the RSRP of the candidate L2 U2N relay UEs, the L2 U2N remote UE may report one or more candidate L2 U2N relay UEs to the base station apparatus. Before reporting one or more candidate L2 U2N relay UEs to the base station apparatus, the L2 U2N remote UE may determine whether the measured RSRP of the candidate L2 U2N relay UEs satisfies the selection criteria for the L2 U2N relay. The L2 U2N remote UE may report only candidate L2 U2N relay UEs that satisfy the selection criteria and match the criteria of the higher layer to the base station apparatus. Furthermore, in a case that reporting one or more candidate L2 U2N relay UEs to the base station apparatus, the L2 U2N remote UE may include, in the report to the base station apparatus, identification information of the candidate L2 U2N relay UEs, identification information of the serving cell of the candidate L2 U2N relay UEs, and measurement results. For the measurement results, the RSRP (SD-RSRP) of the discovery message transmitted by the candidate L2 U2N relay UEs may be used. Note that the identification information may be an identifier (ID).

Furthermore, the L2 U2N remote UE having a serving L2 U2N relay UE may use RSRP (SL-RSRP) measured in sidelink communication with the serving L2 U2N relay UE for the measurement results. Note that in a case that SL-RSRP cannot be used for the measurement results, SD-RSRP may be used. Note that the serving L2 U2N relay UE may be an L2 U2N relay UE that provides the L2 U2N Remote UE with connectivity to the base station apparatus.

There are two resource allocation modes in the NR sidelink communication, a mode in which the UE performs the sidelink transmission using resources scheduled by a base station is called mode 1, and a mode in which the UE automatically selects resources and performs the sidelink transmission is called mode 2. In Mode 1, the UE needs to be RRC_CONNECTED, and in Mode 2, the UE is capable of sidelink transmission regardless of the RRC state or whether the UE is inside or outside the NG-RAN. In Mode 2, the UE automatically selects a resource capable of sidelink transmission from one or multiple resource pools configured before sidelink transmission is performed.

Here, a bandwidth part (BWP) will be described.

The BWP may be a partial band or an entire band of the serving cell. The BWP may be referred to as a Carrier BWP. The terminal apparatus may be configured with one or multiple BWPs. A certain BWP may be configured by information included in system information associated with a synchronization signal detected in initial cell search. A certain BWP may be a frequency bandwidth associated with a frequency for performing the initial cell search. A certain BWP may be configured by RRC signaling (for example, Dedicated RRC signaling). A downlink BWP (DL BWP) and an uplink BWP (UL BWP) may be separately configured. One or multiple uplink BWPs may be associated with one or multiple downlink BWPs. Further, the association between the uplink BWP and the downlink BWP may be a default association, may be association based on RRC signaling (for example, Dedicated RRC signaling), may be association based on physical layer signaling (for example, downlink control information (DCI) notified on a downlink control channel), or may be a combination thereof. Further, a CORE SET may be configured in the downlink BWP.

The BWP may include a group of continuous Physical Resource Blocks (PRBs). For the terminal apparatus in the connected state, parameters of the BWP(s) (one or multiple BWPs) of each component carrier may be configured. As parameters of the BWP of each component carrier, some or all of the followings: (A) a type of a cyclic prefix; (B) a subcarrier interval; (C) a frequency position of the BWP (for example, a start position or a center frequency position on a low frequency side of the BWP) (as the frequency position, for example, an ARFCN may be used, or an offset from a specific subcarrier of the serving cell may be used. The unit of the offset may be the subcarrier unit or the resource block unit. Further, both ARFCN and offset may be configured), (D) bandwidth of the BWP (for example, the number of PRBs), (E) resource configuration information of a control signal, (F) center frequency position of the SS block (for example, the ARFCN may be used as the frequency position, or an offset from a specific subcarrier of the serving cell may be used. Further, the offset may be in units of subcarriers or may be in units of resource blocks. Further, both the ARFCN and the offset may be configured.) part or all may be included. Further, resource configuration information of the control signal may be included in the configuration of the BWP of at least some or all of the PCell and/or PSCell.

The terminal apparatus may transmit and receive in an active BWP among one or more configured BWPs. In one serving cell associated with the terminal apparatus, one or multiple BWPs may be configured. Among the one or multiple BWPs configured for one serving cell associated with the terminal apparatus, at most one uplink BWP and/or at most one downlink BWP may be configured to function as an Active BWP at a certain time. The active BWP of the downlink is also referred to as an active DL BWP. The active BWP of the uplink is also referred to as active UL BWP. Among one or multiple BWPs configured for the terminal apparatus, BWPs each being not an Active BWP may be referred to as Inactive BWPs.

Next, a serving cell will be described. In a terminal apparatus in the RRC connected state (RRC_CONNECTED) in which one serving cell is configured, the serving cell may be configured from one primary cell (PCell). Further, in the terminal apparatus in the RRC connected state in which a plurality of serving cells are configured, the serving cell may refer to a set of a plurality of cells (set of cell(s)) including one or more special cells (SpCells) and one or more all secondary cells (SCells). The SpCell may support PUCCH transmission and contention-based random access (CBRA). The PCell may be a cell used in the RRC connection establishment procedure in a case that the terminal apparatus in the RRC idle state (RRC_IDLE) transitions to the RRC connected state. Further, the PCell may be a cell used in the RRC connection reestablishment procedure in which the terminal apparatus reestablishes the RRC connection. The PCell may be a cell used for a random access procedure in a case of a handover. Further, the SpCell may be a cell used for purposes other than the purposes described above.

In a case that a group of serving cells configured for the terminal apparatus includes an SpCell and one or more SCells, it may be considered that carrier aggregation (CA) is configured for the terminal apparatus. Further, for a terminal apparatus in which CA is configured, a cell providing additional radio resources to the SpCell may mean an SCell.

The Cell Group configured for the terminal apparatus from the base station apparatus will be described. The cell group may include one SpCell. Further, the cell group may include one SpCell and one or more SCells. That is, the cell group may include one SpCell and, optionally, one or more SCells. The cell group may also be expressed as a set of cells (set of cell(s)).

Dual connectivity (DC) may be a technology for performing data communication using radio resources of cell groups each formed by a first base station apparatus (first node) and a second base station apparatus (second node). In a case that DC or MR-DC described below is performed, the base station apparatus may add a cell group to the terminal apparatus. In order to perform DC, the first base station apparatus may add the second base station apparatus. The first base station apparatus may be referred to as a Master Node (MN). The cell group configured by the master node may be referred to as a Master Cell Group (MCG). The second base station apparatus may be referred to as a Secondary Node (SN). The cell group configured by the secondary node may be referred to as a Secondary Cell Group (SCG). Note that the master node and the secondary node may be configured in the same base station apparatus.

Further, in a case that DC is not configured, the cell group configured in the terminal apparatus may be called MCG. In the case that DC is not configured, the SpCell configured for the terminal apparatus may be the PCell. Further, NR in which DC is not configured may be referred to as NR stand-alone.

The UE 122 may receive a special cell (SpCell) configuration from the gNB 102. For example, the RRC reconfiguration message may include a cell group configuration (an information element named Cell Group Config), and the cell group configuration may include a special cell configuration (an information element named spCellConfig). An information element named spCellConfigDedicated included in the information element named spCellConfig may be an information element indicating a cell configuration dedicated to the UE 122 configured by this SpCellConfig. The information element named spCellConfigDedicated may be rephrased as SpCellConfig Dedicated or SpCell dedicated configuration. The information element named spCellConfigDedicated may include a parameter of a BWP identifier named a first active downlink BWP identifier (first Active Downlink BWP-Id) to be described later. Further, the configuration of the special cell may include a reconfiguration with synchronization (an information element named reconfiguration With Sync). An information element named spCellConfigCommon included in the information element named reconfiguration WithSync may be used to configure cell-specific parameters of the serving cell of the UE 122 (that is, the special cell). In order to clearly indicate that a certain wording is an information element, the wording “IE” may be added. For example, a reconfiguration IE with synchronization may be included in the RRC reconfiguration message, and the UE 122 that receives the RRC reconfiguration message may perform a reconfiguration with synchronization (procedure) in accordance with the RRC reconfiguration message.

Next, radio link monitoring (RLM) in Uu will be described.

In the RRC connected state, the terminal apparatus may perform the RLM in an active BWP to be described later or a BWP designated as a BWP in which radio link monitoring is performed. The RLM may be performed based on a reference signal (for example, CRS in E-UTRA or SSB/CSI-RS in NR) and a signal quality threshold. The reference signal may include an SSB. The signal quality threshold may be configured by the network, or a default threshold may be used. The SSB-based RLM may be performed based on an SSB associated with an initial DL BWP to be described later. The SSB-based RLM may be configured for the initial DL BWP and one or more DL BWPs including the SSB associated with the initial DL BWP. CSI-RS-based RLM may be performed for other DL BWPs.

In the RLM, the terminal apparatus may declare or detect a radio link failure (RLF) based on any of the following criteria (A) to (D) being met:
(A) A radio problem timer that starts based on in-sync and out-of-sync notifications from the PHY has expired
(B) A timer that starts based on a measurement report of a specific measurement identifier being triggered while the radio problem timer is running has expired
(C) A random access procedure has failed
(D) RLC failure was detected

The terminal apparatus that detects an RLF in the MCG may remain in the RRC-connected state, select an optimal cell, and initiate the reestablishment procedure. Also, in a case that DC is configured, the terminal apparatus that has declared the RLF may remain in the RRC-connected state and notify the network of the RLF. The terminal apparatus may detect the RLF of the MCG based on determining that any of the above-described criteria (A) to (D) is satisfied in the PCell (for example, in the case of (A), the radio problem timer of the PCell expires, and in the case of (C), the random access procedure fails in the MAC of the MCG).

In the terminal apparatus, a reference signal used for RLM may be configured from the network by RRC signaling. A radio link monitoring configuration (RadioLinkMonitoringConfig) may be used for the RRC signaling. The terminal apparatus may perform the RLM using one or more reference signals (referred to as RLM-RS) configured by the radio link monitoring configuration. Further, in a case that the RLM-RS is not designated, the terminal apparatus may perform the RLM by using a default reference signal. The radio link monitoring configuration may be configured in the terminal apparatus for each DL BWP. The radio link monitoring configuration may be configured for the DL BWP of the PCell and/or the PSCell.

In a case that the PHY of the terminal apparatus satisfies the conditions for being in-sync, the PHY may notify a higher layer (RRC layer) of being in sync. In a case that the PHY of the terminal apparatus satisfies the conditions for being out-of-sync, the PHY may notify the higher layer (RRC or the like) of being out of sync.

The radio link monitoring configuration may include information indicating a purpose of monitoring and identifier information indicating a reference signal. For example, the purpose of monitoring may include a purpose of monitoring radio link failure, a purpose of monitoring beam failure, or both purposes. Further, for example, the identifier information indicating the reference signal may include information indicating an SSB-Index of the SSB of the cell. Further, for example, the identifier information indicating the reference signal may include information indicating an identifier linked to a channel state information reference signal (CSI-RS) configured in the terminal apparatus.

In a case that the terminal apparatus is not provided with an RLM-RS and is provided with (a plurality of) TCI states for PDCCH reception including one or more CSI-RSs, the terminal apparatus performs some or all of the following (A) to (B):
(A) In a case that the activated TCI state for PDCCH reception includes only one reference signal, the terminal apparatus uses the reference signal provided in the activated TCI state for radio link monitoring.
(B) In a case that the activated TCI state for PDCCH reception includes two reference signals, the terminal apparatus expects that a QCL type of one reference signal is configured to type D and uses the reference signal with the QCL type configured to type D for radio link monitoring.

In a case that a serving cell has a plurality of configured DL BWPs to be described later, the terminal apparatus may perform RLM using a reference signal corresponding to the RLM-RS in the active DL BWP to be described later. Further, in a case that a serving cell has a plurality of configured downlink BWPs to be described later and an RLM-RS is not provided for the active DL BWP to be described later, the terminal apparatus may perform RLM using (a plurality of) reference signals provided in an activated TCI state for receiving a PDCCH in the CORE SET of the active DL BWP. The terminal apparatus performing the RLM may be said to be a PHY of the terminal apparatus assessing radio link quality. Further, the PHY may notify a higher layer (such as RRC) of out-of-sync in a case that the measured radio link quality becomes worse than a configured threshold.

Based on the above description, various embodiments of the present invention will be described. The above-described processes may be applied to the processes omitted in the following description.

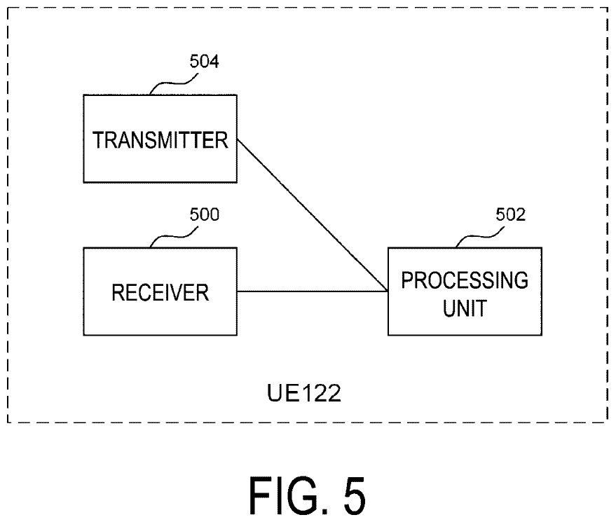

FIG. 5 is a block diagram illustrating a configuration of a terminal apparatus (UE 122) in the present embodiment. Note that FIG. 5 illustrates only the main components closely according to the present embodiment in order to avoid complexity of description.

The UE 122 illustrated in FIG. 5 includes a receiver 500 that receives control information (SCI, MAC control element, RRC signaling, and the like.), discovery message, information including user data, and the like from the other terminal apparatus, a processing unit 502 that performs processing in accordance with parameters included in the received control information or the like, and a transmitter 504 that transmits control information (SCI, MAC control element, RRC signaling, and the like.), discovery message, information including user data, or the like to the other terminal apparatus. Further, the receiver 500 may receive, for example, control information (MAC control element, RRC signaling, and the like) and information including user data from the base station apparatus (gNB 102). Further, the transmitter 504 may transmit, for example, the control information (MAC control element, RRC signaling, and the like) and the information including user data to the base station apparatus (gNB 102). Further, the processing unit 502 may include some or all of functions of various layers (for example, physical layer, MAC layer, RLC layer, PDCP layer, SDAP layer, RRC layer, PC5-S layer, discovery layer, and application layer). That is, the processing unit 502 may include a part or all of a physical layer processing unit (PHY processing unit), a MAC layer processing unit (MAC processing unit), an RLC layer processing unit (RLC processing unit), a PDCP layer processing unit (PDCP processing unit), an SDAP processing unit, an RRC layer processing unit (RRC processing unit), a PC5-S layer processing unit (PC5-S processing unit), a Discovery layer processing unit (Discovery processing unit), and an application layer processing unit.

FIG. 6 is a block diagram illustrating a configuration of the base station apparatus (gNB 102) in the present embodiment. In order to avoid complication of the description, only main components closely according to the present embodiment are illustrated in FIG. 6.

The base station apparatus illustrated in FIG. 6 includes a transmitter 604 that transmits control information (DCI, MAC CE, RRC signaling, and the like) to the UE 122, a processing unit 602 that creates the control information (DCI, MAC CE, RRC signaling, and the like) and transmits the control information to the UE 122 to cause the processing unit 502 of the UE 122 to perform processing, and a receiver 600 that receives control information (UCI, MAC CE, RRC signaling, and the like) from the UE 122. Further, the processing unit 602 may include some or all of functions of various layers (for example, a physical layer, MAC layer, RLC layer, PDCP layer, SDAP layer, RRC layer, and NAS layer). In other words, the processing unit 602 may include a part or all of a physical layer processing unit, a MAC layer processing unit, an RLC layer processing unit, a PDCP layer processing unit, an SDAP processing unit, an RRC layer processing unit, and a NAS layer processing unit.

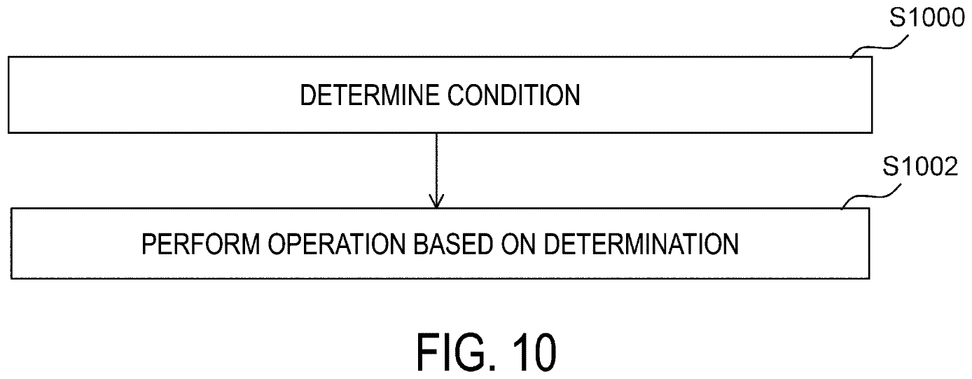

An example of an embodiment in an aspect of the present invention is shown with reference to FIG. 10.

The UE 122 that has detected the RLF of the MCG determines the condition in step S1000, and performs an operation based on the determination in step S1002.

In step S1000, the condition may be, for example, some or all of a plurality of conditions below.
(c-a) A procedure of adding an indirect path is not ongoing
(c-b) A procedure of changing the indirect path is not ongoing

In step S1002, the UE 122 may report the RLF of the MCG to the base station apparatus based on the determination in step S1000 that the condition is satisfied. Further, the UE 122 may initiate a procedure of reestablishing an RRC connection based on the determination in step S1000 that the condition is not satisfied.

The indirect path addition procedure may be a procedure in which the UE 122 connecting to the base station apparatus using only the direct path newly establishes the indirect path to the base station apparatus. Newly establishing the indirect path may be rephrased as, for example, adding an indirect path via a target relay terminal apparatus. Further, the indirect path change procedure may be a procedure in which the UE 122 connecting to the base station apparatus using the direct path and the indirect path, that is, playing the role of the multi-path remote terminal apparatus changes the indirect path with the base station apparatus. Changing the indirect path may be, for example, changing the relay terminal apparatus providing the indirect path from a source multi-path relay terminal apparatus to a target multi-path relay terminal apparatus. The base station apparatus may transmit an RRC reconfiguration message to the UE 122 and the target multi-path relay terminal apparatus to establish the indirect path. In the case of the indirect path change procedure, the base station apparatus may transmit an RRC reconfiguration message to the source multi-path relay terminal apparatus to release the path used before the indirect path is changed. The UE 122 may transmit an RRC reconfiguration complete message to the base station apparatus via at least the direct path to complete the indirect path addition procedure or the indirect path change procedure. The UE 122 that has completed the indirect path addition procedure or the indirect path change procedure may transmit and receive data using the direct path and the indirect path.

In addition to or instead of (c-a) and (c-b), the condition may be, for example, a combination of some or a plurality of conditions among the following conditions:
(c-c) Transmission in the indirect path is not suspended
(c-d) The UE 122 is configured with a multi-path
(c-e) SRB1 is configured as a split bearer and PDCP duplication is configured To report the RLF of the MCG to the base station apparatus, the UE 122 may initiate an MCG failure information procedure. The MCG failure information procedure may be rephrased as initiating a fast MCG recovery procedure to maintain the RRC connection without reestablishment. In the MCG failure information procedure, the UE 122 may transmit an MCG failure information message to the base station apparatus. The UE 122 may also include a failure type in the MCG failure information message. The UE 122 may also include an entry for which a measurement result is available in each measurement object (measObjectNR) configured by a measurement configuration (measConfig) associated with the MCG in a measurement result frequency list (measResultFreqList), and include the measurement result frequency list in the MCG failure information message. The entry may include, for example, a physical cell ID of a serving cell or a neighboring cell, and a result of measuring cell quality corresponding to each physical cell ID, and may also include information indicating a frequency of a measured SSB or CSI-RS. As the cell quality, measurement quantities such as reference signal received power (RSRP), reference signal received quality (RSRQ), and signal to interference plus noise ratio (SINR) may be specified. The MCG failure information may be transmitted via SRB1.

Note that in the above-described example, detecting the RLF of the MCG may be expressed as detecting the RLF in the direct path. Similarly, the RLF of the direct path may be expressed as the RLF of the MCG, and the UE 122 may initiate the MCG failure information procedure to report the RLF of the direct path to the base station apparatus.

In a case that a direct path (MCG) fails in the multi-path relay, information on the failure (MCGFailureInformation) is sent, but in existing procedures, a procedure of sending the information on the failure is initiated even in a situation where the information should not be sent. It is possible to reduce unnecessary operations of the terminal apparatus and recover the RRC connection quickly by appropriately determining the conditions for sending the information on the failure according to an aspect of the present invention.

Further, in the above description, expressions such as “notified” and “indicated” may be interchangeable.

Further, in the above description, expressions such as “link”, “map”, and “associate” may be interchangeable.

In the above description, expressions such as “included”, “being included”, and “was included” may be interchangeable.

Further, in the above description, “the”may be interchangeable with “the above-described”.

Further, in the above description, expressions such as “determined to be”, “is configured”, and “is included” may be interchangeable.

Further, in the example of each processing or the example of the flow of each processing in the above description, some or all of the steps need not be performed. In the example of each processing or the example of the flow of each processing in the above description, the order of the steps may be different from each other. In the example of each processing or the example of the flow of each processing in the above description, a part or all of the processing in each step need not be performed. In the example of each processing or the example of the flow of each processing in the above description, the order of processing in each step may be different from each other. In the above description, “to perform B based on satisfaction of A” may be replaced with “to perform B”. In other words, “to perform B” may be performed independently of “satisfaction of A”.

In the above description, “A may be rephrased as B” may include the meaning of rephrasing B as A in addition to rephrasing A as B.

In a case that the above description contains “C may be D” and “C may be E”, this means inclusion of “D may be E”. In a case that the above description contains “F may be G” and “G may be H”, this may mean inclusion of “F may be H”.

Further, in the above description, in a case that a condition “A” and a condition “B” are conflicting conditions, the condition “B” may be expressed as “another” condition of the condition “A”.

Further, in the above description, “determining whether or not it is A” may mean “determining that it is A” or “determining that it is not A”. “Determining that it is not A” may mean “not determining that it is A”, and “determining that it is A” may mean “not determining that it is not A”.

A program that operates on an apparatus according to the present embodiment may be a program that controls a central processing unit (CPU) or the like to cause a computer to function in order to realize the functions of the present embodiment. The program or information handled by the program is temporarily loaded into a volatile memory such as a random access memory (RAM) during processing, or stored in a non-volatile memory such as a flash memory or a hard disk drive (HDD), and is read, modified, and written by the CPU as necessary.

The apparatus in the above-described embodiment may be partially realized by a computer. In this case, a program for implementing this control function may be implemented by recording the program in a computer-readable recording medium and causing a computer system to read and perform the program recorded in the recording medium. It is assumed that the “computer system” refers to a computer system built into the apparatuses, and the computer system includes an operating system and hardware components such as a peripheral device. Further, the “computer-readable recording medium” may be any of a semiconductor recording medium, an optical recording medium, a magnetic recording medium, and the like.

Further, the term “computer-readable recording medium” may also include something that dynamically holds a program for a short period of time, such as a communication line in a case that a program is transmitted via a network such as the Internet or a communication line such as a telephone line, or something that holds a program for a certain period of time, such as volatile memory within a computer system that is a server or client in that case. Further, the above-described program may be configured to realize some of the functions described above, and additionally may be configured to realize the functions described above, in combination with a program already recorded in the computer system.

Further, each functional block or feature of the apparatus used in the above-described embodiment may be implemented or performed by an electric circuit, typically, an integrated circuit or a plurality of integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or the processor may be a processor of known type, a controller, a micro-controller, or a state machine instead. The general-purpose processor or the above-described circuits may include a digital circuit, or may include an analog circuit. Further, in a case that with advances in semiconductor technology, a circuit integration technology appears that replaces the present integrated circuits, it is also possible to use an integrated circuit based on the technology.

The present embodiment is not limited to the above-described embodiment. Although apparatuses have been described as an example in the embodiment, the present embodiment is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although the present embodiment has been described in detail above with reference to the drawings, the specific configuration is not limited to the embodiment, and design changes within the scope of the present embodiment are also included. Further, various modifications are possible within the scope of the present embodiment defined by claims, and embodiments that are made by suitably combining technical means disclosed according to the different embodiments are also included in the technical scope of the present embodiment. Further, configurations in which elements described in the above embodiments and having the same effects are substituted with each other are included.

### INDUSTRIAL APPLICABILITY

An aspect of the present invention can be used, for example, in a communication system, a communication device (for example, a mobile phone device, a base station apparatus, a wireless LAN device, or a sensor device), an integrated circuit (for example, a communication chip), a program, or the like.

### REFERENCE SIGNS LIST

100 ng-eNB
102 gNB
110, 112, 114 Interface
122 UE
200, 700 PHY
202, 702 MAC
204, 704 RLC
206, 706 PDCP
208, 708 RRC
210 PC5-S
310, 710 SDAP
400 Discovery
500, 600 Receiver
502, 602 Processing unit
504, 604 Transmitter
712 NAS
800 SRAP

1. A terminal apparatus configured to communicate with a base station apparatus, the terminal apparatus comprising:
a transmitter; and
a processor,
wherein the processor determines whether a procedure of changing an indirect path and a procedure of adding the indirect path are ongoing in a case that a radio link failure of a direct path is detected,
the transmitter reports the radio link failure of the direct path to the base station apparatus, based on the processor determining that neither the procedure of changing the indirect path nor the procedure of adding the indirect path is ongoing,
the direct path is a path connected to the base station apparatus via a Uu interface, and
the indirect path is a path connected to the base station apparatus via a relay terminal apparatus.

2. A method for a terminal apparatus configured to communicate with a base station apparatus, the method comprising:
determining whether a procedure of changing an indirect path and a procedure of adding the indirect path are ongoing in a case that a radio link failure of a direct path is detected; and
reporting the radio link failure of the direct path to the base station apparatus, based on determining that neither the procedure of changing the indirect path nor the procedure of adding the indirect path is ongoing,
wherein the direct path is a path connected to the base station apparatus via a Uu interface, and
the indirect path is a path connected to the base station apparatus via another terminal apparatus.

3. An integrated circuit implemented in a terminal apparatus configured to communicate with a base station apparatus, the integrated circuit comprising:
a function of determining whether a procedure of changing an indirect path and a procedure of adding the indirect path are ongoing in a case that a radio link failure of a direct path is detected; and
a function of reporting the radio link failure of the direct path to the base station apparatus, based on determining that neither the procedure of changing the indirect path nor the procedure of adding the indirect path is ongoing,
wherein the direct path is a path connected to the base station apparatus via a Uu interface, and
the indirect path is a path connected to the base station apparatus via another terminal apparatus.
